(19) United States
(12) Patent Application Publication
(10) Pub. No.: US 2026/0299603 A1
(43) Pub. Date: Oct. 1, 2026

(54) APPARATUS AND PROCESS FOR UNMANNED TASKING

(71) Applicant: The Penn State Research Foundation, University Park, PA (US)

(72) Inventors: Xinghao Peng, University Park, PA (US); Runsang Liu, University Park, PA (US); Hui Yang, University Park, PA (US)

(73) Assignee: The Penn State Research Foundation, University Park, PA (US)

(21) Appl. No.: 19/631,625

(22) Filed: Mar. 27, 2026

Related U.S. Application Data
(60) Provisional application No. 63/778,710, filed on Mar. 27, 2025.

(51) Int. Cl. G05D 1/646; G05D 1/246; G05D 1/644; G05D 1/69

(52) U.S. Cl. CPC G05D 1/646; G05D 1/246; G05D 1/644; G05D 1/69

(57) ABSTRACT

Apparatuses, methods, and systems can be configured to perform optimized tasking of unmanned vehicles. Embodiments can include a system having at least one computing device having at least one processor communicatively connected to a non-transitory computer-readable medium. The computer readable medium can have code stored thereon such that the system is configured to perform optimized tasking of unmanned vehicles.

### CROSS-REFERENCE TO RELATED APPLICATIONS

This patent is related to and claims the benefit of priority of U.S. Provisional Application 63/778,710, filed on Mar. 27, 2025, the entire contents of which are incorporated by reference.

### STATEMENT REGARDING FEDERALLY SPONSORED RESEARCH OR DEVELOPMENT

This invention was made with government support under Grant No. IIS2302834 awarded by the National Science Foundation. The Government has certain rights in the invention.

### FIELD

Embodiments relate to systems, methods, and apparatuses configured to provide optimized tasking (e.g., deployment) of unmanned vehicles (e.g., unmanned aerial vehicles (UAVs)) in environments having spatially and temporally varying demand. In particular, embodiments relate to a system for optimized tasking of unmanned vehicles having at least one computing device and a plurality of unmanned vehicles communicatively connected to the at least one computing device, the system being configured to receive external and/or mission data, generate a demand density map based on the received data, calculate a demand value for each cell of a uniform grid of the demand density map, generate a Voronoi tessellation including a plurality of Voronoi coverage polygons, iteratively execute a cost function until convergence is achieved, assign one or more unmanned vehicles to a target deployment locations, determine an executable trajectory for each unmanned vehicle, and transmit the executable trajectory for each unmanned vehicle to the plurality of vehicles.

### BACKGROUND

Groups of unmanned vehicles, such as a fleet of unmanned aerial vehicles (UAVs), are increasingly deployed in a variety of diverse business sectors, for example, logistics, disaster monitoring, emergency response, etc., to perform a variety of tasks associated with a geographic area or region. For example, unmanned vehicles (e.g., UAVs) may be deployed to deliver payloads, such as deliverable consumer/business products, emergency supplies, or disaster response supplies, to specific geographic areas, and/or to actively monitor (e.g., collect informational/monitoring data) specific geographic areas in which an event that requires a response (e.g., delivery of a payload) and/or monitoring (e.g., video monitoring) is taking place. The geographic area/region may be divided into smaller sub-areas or sub-regions that make up the geographic area, and one or more individual unmanned vehicles of the group can be deployed to a specific sub-area based on a quantified demand associated with a given sub-area.

An exemplary unmanned vehicle tasking (e.g., deployment) scenario includes a wildfire scenario, in which a fleet of UAVs can be tasked with deploying over the entire geographic area to monitor and/or suppress the wildfire, for example, by collecting data (e.g., thermal data, video/image data, air quality data, etc.) and/or delivering a payload (e.g., fire suppressant materials/liquids/foams, etc.), respectively. In such a scenario, the ability to deploy one or more UAVs to each of the geographic sub-areas based on demand can ensure that the entire geographic coverage area of the wildfire can be actively being monitored and/or suppressed, and that specific sub-areas having a higher degree of demand (e.g., areas in which the wildfire is hotter, more intense, has an increased chance of spreading, etc.) are prioritized in terms of monitoring, payload delivery, etc.

### SUMMARY

Currently existing systems and methods for tasking (e.g., deploying) unmanned vehicles typically assume a uniform or static demand, for example, that each sub-area of a given geographic area has the same level of demand (uniform) and/or that the initial level of demand of a given sub-area will remain at the same level of demand (static). As such, these systems and methods result in a fixed or pre-determined deployment of unmanned vehicles that is based on the assumed uniform and/or static demand. Such systems are unable to account for rapidly changing demand across the geographic region, and thus, can result in a sub-optimal tasking (e.g., deployment) of unmanned vehicles and/or require human intervention to alter the tasking (e.g., deployment) of the unmanned vehicles to accommodate a change in level of demand in a given sub-area of the geographic area. For example, the geographic bounds of a wildfire can shift rapidly, due to winds, environmental factors, etc., and the conditions (e.g., heat, intensity, etc.) of a wildfire within a given sub-area can rapidly change, and tasking the unmanned vehicles based on an assumed static or uniform demand cannot properly account for such rapid changes.

We have developed methods and systems to provide optimized, adaptive tasking of unmanned vehicles capable of determining real-time demand level distribution across a geographic area and adaptively adjusting tasking of unmanned vehicles in real-time based on heterogenous or dynamic spatiotemporal demand distributions.

Embodiments can relate to a system for optimized tasking of unmanned vehicles. The system can include at least one computing device comprising at least one processor communicatively connected to a non-transitory computer-readable storage medium, and a plurality of unmanned vehicles communicatively connected to the at least one computing device. Each unmanned vehicle can be configured to transmit data to and receive data from the at least one computing device, and can include a control system configured to operatively control the unmanned vehicle. The non-transitory computer-readable storage medium can have code stored thereon such that, at each checkpoint time interval of a mission time interval, the system can be configured to receive, by the at least one processor, at least one of external data or mission data from one or more external data sources or one or more mission data sources in communicative connection with the at least one computing device. The system can generate, in a map coordinate system, a demand density map of a geographic area in which the plurality of unmanned vehicles are to perform one or more tasks. The demand density map can include one or more grids or masks including the external and/or mission data, and can be aligned over a uniform cell grid of the demand density map. The system can calculate a demand value for each cell of the uniform cell grid based on the external data and/or the mission data correspondingly aligned with each cell center in the one or more grids or masks. The system can generate a Voronoi tessellation including a plurality of Voronoi polygons, with each polygon corresponding to an unmanned vehicle and including a target deployment location. The system can iteratively execute a cost function, wherein the demand value for each cell of the uniform cell grid and each target deployment location can be provided as input to the cost function. After each iteration, each target deployment location can be updated based on the cost function output, and the Voronoi tessellation can be updated based on the updated target deployment locations. The cost function can be iteratively executed until it is determined that convergence is achieved. The system can assign one or more unmanned vehicles to each target deployment location, can determine an executable trajectory for each unmanned vehicle, and can transmit the executable trajectory for each unmanned vehicle to the plurality of unmanned vehicles. The control system of each unmanned vehicle can be further configured to cause each unmanned vehicle to move within the geographic area based on its respective executable trajectory.

In some embodiments, the external data can include at least one of satellite image data, incident report data, weather data, restricted area data, or environmental modeling data.

In some embodiments, the mission data can include at least one of unmanned vehicle operational data or mission command data. In some embodiments, the mission command data can include at least one of a target focus location or a target focus area, and a priority factor.

In some embodiments, calculating a demand value for each cell of the uniform cell grid based on the external data and/or the mission data correspondingly aligned with each cell center in the one or more grids or masks can include converting, by the at least one processor, the external and/or mission data of each mask and grid to a normalized nonnegative demand value, and determining a total demand value for each cell of the uniform cell grid based on a combination of each normalized nonnegative demand value correspondingly aligned with the cell.

In some embodiments, one or more unmanned vehicles can be assigned to each target deployment location using a Hungarian algorithm.

In some embodiments, the Hungarian algorithm can assign the one or more unmanned vehicles to each target deployment location based on a cost matrix output by an A* search.

In some embodiments, the executable trajectory for one or more unmanned vehicles of the plurality of unmanned vehicles can be determined based on one or more unmanned vehicle operational constraints.

In some embodiments, the system can be further configured to generate, by the at least one processor, one or more control signals for each unmanned vehicle based on the determined executable trajectory for each unmanned vehicle, and can transmit, via the communicative connection, the one or more control signals for each unmanned vehicle to each unmanned vehicle to cause the unmanned vehicle to move toward its target deployment location.

In some embodiments, the system can be further configured to transmit, via the communicative connection, the executable trajectory for each unmanned vehicle to one or more first unmanned vehicles of the plurality, wherein the communicative connection can be a first communicative connection and wherein the one or more first unmanned vehicles of the plurality can be in a second communicative connection with one or more second unmanned vehicles of the plurality. In some embodiments, the system can be further configured to transmit, via the second communicative connection, each executable trajectory for each one or more second unmanned vehicles to each of the one or more second unmanned vehicles.

In some embodiments, the system can be further configured to generate one or more visual representations including at least one of a current Voronoi tessellation, the current target deployment location of each unmanned vehicle, or the demand density map, and can transmit the one or more visual representations to at least one operator computing device in communicative connection with the at least one computing device.

Embodiments can also relate to a method for optimized tasking of unmanned vehicles. The method can include performing, at each checkpoint time interval of a mission time interval comprising a plurality of checkpoint time intervals, by at least one processor of at least one computing device, the steps of: receiving at least one of external data or mission data from one or more external data sources or one or more mission data sources; generating, in a map coordinate system, a demand density map of a geographic area in which the plurality of unmanned vehicles are to perform one or more tasks, the demand density map including one or more grids or masks including the external and/or mission data and aligned over a uniform cell grid; calculating a demand value for each cell of the uniform cell grid based on the external data and/or the mission data correspondingly aligned with each cell center in the one or more grids or masks; generating a Voronoi tessellation including a plurality of Voronoi polygons, with each polygon corresponding to an unmanned vehicle and including a target deployment location; iteratively executing a cost function, wherein the demand value for each cell of the uniform cell grid and each target deployment location can be provided as input to the cost function, and wherein, after each iteration, each target deployment location can be updated based on the cost function output and the Voronoi tessellation can be updated based on the updated target deployment locations, and the cost function can be iteratively executed until convergence is achieved; assigning one or more unmanned vehicles to each target deployment location; determining an executable trajectory for each unmanned vehicle; transmitting the executable trajectory for each unmanned vehicle to the plurality of unmanned vehicles; and wherein the control system of each unmanned vehicle can be further configured to cause each unmanned vehicle to move within the geographic area based on its respective executable trajectory.

In some embodiments, the external data can include at least one of satellite image data, incident report data, weather data, restricted area data, or environmental modeling data.

In some embodiments, the mission data can include at least one of unmanned vehicle operational data or mission command data, and the mission command data can include at least one of a target focus location or a target focus area, and a priority factor.

In some embodiments, calculating a demand value for each cell of the uniform cell grid based on the external data and/or the mission data correspondingly aligned with each cell center in the one or more grids or masks can include converting, by the at least one processor, the external and/or mission data of each mask and grid to a normalized nonnegative demand value, and determining a total demand value for each cell of the uniform cell grid based on a combination of each normalized nonnegative demand value correspondingly aligned with the cell.

In some embodiments, one or more unmanned vehicles can be assigned to each target deployment location using a Hungarian algorithm.

In some embodiments, the Hungarian algorithm can assign the one or more unmanned vehicles to each target deployment location based on a cost matrix output by an A* search.

In some embodiments, the executable trajectory for one or more unmanned vehicles of the plurality of unmanned vehicles can be determined based on one or more unmanned vehicle operational constraints.

In some embodiments, the method can further include generating, by the at least one processor, one or more control signals for each unmanned vehicle based on the determined executable trajectory for each unmanned vehicle, and transmitting, via the communicative connection, the one or more control signals for each unmanned vehicle to each unmanned vehicle to cause the unmanned vehicle to move toward its target deployment location.

In some embodiments, the method can further include transmitting, via the communicative connection, the executable trajectory for each unmanned vehicle to one or more first unmanned vehicles of the plurality, wherein the communicative connection can be a first communicative connection and wherein the one or more first unmanned vehicles of the plurality can be in a second communicative connection with one or more second unmanned vehicles of the plurality, and transmitting, via the second communicative connection, each executable trajectory for each one or more second unmanned vehicles to each of the one or more second unmanned vehicles.

In some embodiments, the method can further include generating, by the at least one processor, one or more visual representations including at least one of a current Voronoi tessellation, the current target deployment location of each unmanned vehicle, or the demand density map, and transmitting the one or more visual representations to at least one operator computing device in communicative connection with the at least one computing device.

Other details, objectives, and advantages of a system for optimized tasking of unmanned vehicles, and methods of using the same will become apparent as the following description of certain exemplary embodiments thereof proceeds.

### BRIEF DESCRIPTION OF THE DRAWINGS

The above and other objects, aspects, features, advantages, and possible exemplary applications of the present innovation will be more apparent from the following more particular description thereof, presented in conjunction with the following drawings. Like reference numbers used in the drawings may identify like components.

FIG. 1 is a block diagram of an exemplary system for optimized tasking of unmanned vehicles.

FIG. 2 is a flowchart depicting steps of an exemplary method for optimized tasking of unmanned vehicles.

FIG. 3 is a flowchart depicting additional steps of the exemplary method for optimized tasking of unmanned vehicles of FIG. 2.

FIG. 4 depicts a series of Voronoi tessellations (top) and corresponding demand density maps including unmanned vehicle optimization paths (bottom) as they evolve from 5 iterations of a cost function through 100 iterations of the cost function under a fixed demand distribution.

FIG. 5 depicts a continuation of the series of Voronoi tessellations (top) and corresponding demand density maps including unmanned vehicle optimization paths (bottom) as they evolve from 250 iterations to 297 iterations of the cost function.

FIG. 6 depicts a series of Voronoi tessellations optimized to adapt to dynamic demand density.

FIG. 7 depicts a pair of Voronoi tessellations optimized to adapt to dynamic demand density.

FIG. 8 depicts a Voronoi tessellation including a plurality of Voronoi coverage polygons each having a current target deployment location.

FIG. 9 depicts an update of the current target deployment locations of the Voronoi tessellation of FIG. 8 based on a gradient output of a cost function.

FIG. 10 depicts an updating of the Voronoi tessellation of FIG. 8 based on the updated target deployment locations of FIG. 9.

FIG. 11 is a visual representation of a demand density map depicting optimized deployment locations for a plurality of unmanned vehicles subjected to a 0.15 altitude limit constraint.

FIG. 12 depicts a Voronoi tessellation including optimized target deployment locations corresponding to the demand density map of FIG. 11.

FIG. 13 is a visual representation of a demand density map depicting optimized deployment locations for a plurality of unmanned vehicles subjected to a 0.14 altitude limit constraint.

FIG. 14 depicts a Voronoi tessellation including optimized target deployment locations corresponding to the demand density map of FIG. 13.

FIG. 15 is a visual representation of a demand density map depicting optimized deployment locations for a plurality of unmanned vehicles subjected to a 0.13 altitude limit constraint.

FIG. 16 depicts a Voronoi tessellation including optimized target deployment locations corresponding to the demand density map of FIG. 15.

FIG. 17 depicts a series of snapshots of evolving spatiotemporal demand in an operating region.

FIG. 18 is a visual representation of operational trajectories of an unmanned aerial vehicle swarm of 30 drones navigating around a restricted area over 10 checkpoints tracking evolving demand.

FIG. 19 is a visual representation of operational trajectories of an unmanned aerial vehicle swarm of 50 drones navigating around the restricted area over 10 checkpoints tracking evolving demand of FIG. 18.

FIG. 20A is a graphical representation of a convergence of a cumulative cost over optimization iterations under varying speed limits with a fixed abundant battery budget.

FIG. 20B is a graphical representation of a convergence of a cumulative cost over optimization iterations under varying battery budgets with a fixed abundant speed limit.

FIG. 21 is a graphical representation of cumulative unmanned aerial vehicle failure percentage as a function of operating time under different Weibull parameter settings.

FIG. 22A depicts a visual representation of a demand density map having a Voronoi tessellation overlaid depicting drone failures at a checkpoint interval t=3.

FIG. 22B depicts a visual representation of an updated demand density map having a Voronoi tessellation overlaid depicting an updated Voronoi tessellation of the Voronoi tessellation of FIG. 22A that is updated without introducing any backup drones at a checkpoint interval t=4.

FIG. 23A depicts a visual representation of an updated demand density map having a Voronoi tessellation overlaid depicting an updated Voronoi tessellation of the Voronoi tessellation of FIG. 22A that is updated with introducing backup drones at a checkpoint interval t=4.

FIG. 23B depicts a visual representation of an updated demand density map having a Voronoi tessellation overlaid depicting an updated Voronoi tessellation of the Voronoi tessellation of FIG. 22A at a checkpoint t=6.

FIG. 24A depicts a visual representation of an updated demand density map having a Voronoi tessellation overlaid depicting an updated Voronoi tessellation of the Voronoi tessellation of FIG. 23B that is updated without introducing any backup drones at a checkpoint interval t=7.

FIG. 24B depicts a visual representation of an updated demand density map having a Voronoi tessellation overlaid depicting an updated Voronoi tessellation of the Voronoi tessellation of FIG. 23B that is updated with introducing backup drones at a checkpoint interval t=7.

FIG. 25 is a graphical representation of final cumulative coverage cost under different backup capacities and Weibull failure parameters.

FIG. 26A depicts an exemplary georeferenced thermal infrared raster converted into a cellwise demand density map.

FIG. 26B depicts the cellwise demand density map of FIG. 26A after the application of neighborhood-based smoothing.

### DETAILED DESCRIPTION

The following description is of exemplary embodiments that are presently contemplated for carrying out the present invention. This description is not to be taken in a limiting sense but is made merely for the purpose of describing the general principles and features of the present invention. The scope of the present invention is not limited by this description.

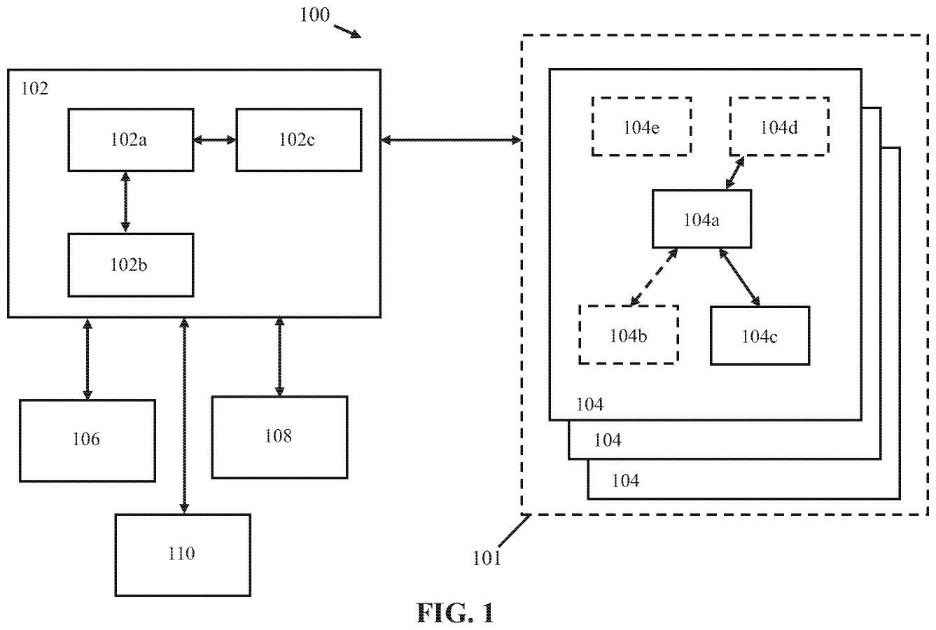

Referring to FIG. 1, an unmanned tasking system 100 for optimized tasking of unmanned vehicles 104 can include at least one computing device 102 including at least one processor 102a communicatively connected to a non-transitory computer-readable memory 102b, and at least one transceiver 102c. The computing device 102 can include any suitable computing device, such as a user device, an onboard processor within an unmanned vehicle 104, a centralized or distributed computing device, a remote server, an edge computing device, a cloud-based or hybrid computing resource, etc.

The transceiver 102c can include a local area network transceiver, a wide area network transceiver, a Wi-Fi transceiver, a Bluetooth transceiver, a cellular network transceiver, an Ultra-Wide Band (UWB) transceiver, and/or other type of transceiver or combination of transceivers. The type of communicative connection(s) facilitated by the at least one transceiver 102c can facilitate the collection and storage of operational data, external data, sensor data, mission command data, unmanned vehicle operational data, control signal data, and/or user input data, and the processing and/or providing of that data to other computing device(s) 102, one or more unmanned vehicles 104, etc.

The non-transitory memory 102b can include flash memory, a hard drive, a solid-state drive, or other non-transitory memory. In some embodiments, the non-transitory memory 102b can include a type of non-transitory computer-readable medium that is accessible to the processor(s) 102a, allowing the processor to run code (e.g., execute an algorithm) and/or to access one or more software modules, artificial intelligence (AI) models, etc., stored in the memory 102b, for example.

The non-transitory memory 102b can include flash memory, a hard drive, a solid-state drive, or other non-transitory memory. In some embodiments, the non-transitory memory 102b can include a type of non-transitory computer-readable medium that is accessible to the processor(s) 102a, allowing the processor to run code and/or to access one or more artificial intelligence (AI) models stored in the memory 102b, for example.

The processor(s) 102a can include a central processing unit, microcontroller, core processor, server (e.g., cloud server), array of processors, or other type of processor. The memory 102b can be communicatively connected to the processor(s) 102a so that the processor(s) 102a can run and/or access at least one algorithm, application (App), at least one software module (Mod), at least one artificial intelligence (AI) model (AI), and/or can process code stored in the memory 102b. The memory 102b can also have at least one data store (DS), which can include code, operational data, external data, sensor data, mission command data, unmanned vehicle operational data, control signal data, user input data, files, databases, libraries, and/or other types of stored data that may be used when the processor 102a runs the code of one or more applications (App), software modules, etc. For instance, the processor(s) 102a can process code of an application (App), software module, and/or AI model to run the application, software module, and/or AI model to perform a pre-defined method in accordance with programming code for the application that defines the method to be performed.

The system 100 can include a plurality 101 of unmanned vehicles 104 in communicative connection with the computing device(s) 102, and each of the unmanned vehicles 104 of the plurality 101 can be configured to autonomously perform one or more tasks, such as navigating (e.g., deploying), monitoring (e.g., collecting/generating monitoring data), delivering a payload, etc. The unmanned vehicles 104 may include, for example, unmanned aerial vehicles (UAVs) such as quadcopters or fixed-wing drones, autonomous ground vehicles such as rovers or self-driving cars, surface or underwater vessels, or any suitable mobile autonomous platforms. In some embodiments, the plurality 101 of unmanned vehicles 104 can include any number and/or type of unmanned vehicle 104.

In some embodiments, each of the one or more of the unmanned vehicles 104 of the plurality 101 can include at least one processor 104a in communicative connection with at least one transceiver 104c. The transceiver(s) 104c can be in communicative connection with the computing device(s) 102, one or more additional transceiver(s) 104c of one or more different unmanned vehicles, or any communicably connectable element of the system 100, and configured to transmit data thereto and/or receive data therefrom. In some embodiments, one or more of the unmanned vehicles 104 of the plurality 101 can include a computer-readable non-transitory memory 104b, one or more payloads 104e, and/or one or more sensors 104d. A payload 104e can include any type of deliverable to be transported/delivered by an unmanned vehicle 104. For example, a payload may include physical packages or products, raw materials, chemicals (e.g., fire suppression chemicals), or any other type of deliverable that can be transported/delivered by one or more unmanned vehicles 104. The sensors 110 can include any suitable type of sensor, such as image sensors (e.g., cameras), environmental sensors (e.g., depth, proximity, temperature, light, etc.), etc.

In some embodiments, the system 100 can include one or more sensors 110 (e.g., environmental sensors, image sensors, etc.) configured to generate sensor data associated with the geographic region (e.g., external data) in which the plurality of unmanned vehicles 104 are to perform one or more tasks. In some embodiments, the system 100 can include one or more external data sources 106 configured to generate/provide external data associated with the geographic region in which the plurality of unmanned vehicles 104 are to perform one or more tasks. For example, the external data sources 106 can include satellite imagery sources, emergency/disaster modeling sources, incident report sources (e.g., emergency dispatch/call centers), weather data sources, governmental services/databases (e.g., regarding restricted areas, urban exclusion zones, etc.), topographical data sources, or any other type of external data source capable of providing data relevant to the tasking of one or more unmanned vehicles 104.

The computing device(s) 102 can be in communicative connection (e.g., via wired and/or wireless connection) with one or more external data sources 106 and/or one or more sensors 110 and configured to receive, from the external data sources 106 and/or the sensor(s) 110, external data associated with a geographic region (or area) in which the plurality 101 of unmanned vehicles 104 are to perform one or more tasks. The sensor(s) 110 can include any suitable type of sensor configured to generate sensor data relating to physical conditions or parameters of the geographic region that may be relevant to a demand density of the geographic region and/or the one or more tasks to be performed by the unmanned vehicles 104.

The external data can include any suitable type of data associated with and/or corresponding to the physical locations/boundaries of the geographic area, physical condition/status of the geographic area and/or geographic sub-areas within the geographic area, and/or any external conditions that may impact a demand level associated with the geographic region and/or the ability of the plurality 101 of unmanned vehicles 104 to perform one or more tasks, for example, environmental conditions which may affect one or more physical operations of the unmanned vehicles 104, flight path obstructions (e.g., no-fly-zones), etc. It should be understood that the above is merely exemplary and that the external data can include any type of data that can be utilized to determine one or more demand levels associated with the geographic region, the demand level(s) being representative of a demand for one or more tasks performed by one or more unmanned vehicles 104.

As described above, the system 100 can be configured to receive and/or acquire numerous types of external data, each type of which may be initially formatted as disparate data, for example, the external data can include raster data, vector data, point data, sensor data, etc. In some embodiments, the processor(s) 102a can be configured to, upon receiving the external data, format the external data into a common spatial representation, for example, a coordinate map and/or demand density map spatial representation including one or more aligned masks and/or grids including the external data. For example, the processor(s) 102a can be configured to define an operating region (“P”) in a map coordinate system, such as latitude/longitude or Universal Transverse Mercator (UTM). In some embodiments, the operating region may be defined as a polygon in the map coordinate system. It should be understood that the above is merely exemplary and that the common spatial representation can include any suitable type of common spatial representation, such as a matrix, plot, map, etc.

In some embodiments, once the operating region (e.g., P) has been defined, the processor(s) 102a can generate a uniform cell grid (e.g., N×N cells) over the operating region, such that the operating region is divided into a plurality of uniform cells. The center of each cell can define a cell location (“s”) as s=(x, y), with x and y being coordinates of the coordinate mapping system. The processor(s) 102a can convert the external data into one or more aligned grids or masks on the map coordinate system (e.g., grids or masks over operating region P). For example, external raster data can be resampled to the uniform cell grid (e.g., a georeferenced raster having a different resolution than the map coordinate system), external vector data can be rasterized into one or more masks over the uniform cell grid, and/or external point data can be converted into a grid, for example, using bin counts or kernel smoothing. It should be understood that the above is merely exemplary and that the processor(s) 102a can be configured to convert any suitable type of external data to a mask, grid, or any other suitable type of map coordinate system data representation in which the external data can be associated with (e.g., correspond to) one or more uniform cells within the operating region (P).

As such, the processor(s) 102a can generate, based on the external data, a coordinate map including a plurality of layers (e.g., aligned grids and/or masks), with each layer including external data. In some embodiments, for example, embodiments in which only one external data source may be available, the coordinate map may include a single layer (e.g., aligned grid or mask) including the external data. In some embodiments, the plurality of layers can include one or more layers for each data type of external data and/or one or more layers for each external data source from which the external data is received. The system 100 can be configured to (e.g., via execution of code, an algorithm, etc., by the processor(s) 102a) determine a demand density as a function of location (e.g., “f(s)”) for each of the uniform cells of the operating region P, based on the external data contained in the plurality of layers of the coordinate map and corresponding to a given uniform cell.

As described above, in some embodiments, each of the layers (e.g., masks and/or grids) may represent external data having different units and/or ranges, for example, a thermal infrared brightness temperature raster may include pixel brightness/color/intensity values (e.g., pixel brightness/color/intensity values obtained via image processing by the processor(s) 102a), whereas point data may be represented as an integer (e.g., an integer value for a given cell that is incremented for each instance of point data corresponding to that cell). The processor(s) 102a can, prior to determining demand density, pre-process the external data of each of the layers (e.g., aligned grids and/or masks) to obtain, scale, normalize, and/or otherwise process the external data of each layer such that a single demand density for each uniform cell can be determined based on the external data corresponding to (e.g., associated with) each uniform cell, regardless of data type, format, etc.

For example, in some embodiments, external data in the form of image data (e.g., satellite image data) may undergo imaging processing (e.g., via an execution of an image processing algorithm, accessing an image processing module, etc., by the processor(s) 102a) such that a pixel intensity/brightness/color value for each pixel of the image data can be obtained. In some embodiments, the values contained in each of one or more layers (e.g., aligned grids and/or masks) of the plurality of layers may be normalized (e.g., by the processor(s) 102a), for example, using min-max scaling, z-score normalization, applying linear and/or non-linear transformations, or any other suitable normalization methods, such that the values of each layer may be converted to the same value scale and/or bounded to a nonnegative field (e.g., field of values between 0 and 1).

For example, for a layer (e.g., aligned grid) including raster data (e.g., a thermal infrared brightness temperature raster), a demand intensity value for each uniform cell (e.g., location s) of the layer based on the pixel intensity value of each uniform cell. That is, for a given uniform cell, a demand intensity value (e.g., f₀(s)) may be determined based on the pixel intensity value (e.g., I(s)) for said uniform cell, for example, f₀S may be determined to be equal to I(s) (e.g., f₀(s)=I(s)). In some embodiments, the processor(s) 102a can define a mask or filter (e.g., M(s)) based on a predetermined threshold (e.g., T), such that only cells including a value (e.g., pixel intensity value) that is greater than or less than the threshold may be marked/masked/etc. In such an embodiment, the demand intensity value f₀(s) can be determined based on the value (e.g., pixel intensity) and the mask for the uniform cell, for example, f₀(s)=M(s)!(I(s)−T). In some embodiments, the processor(s) 102a can be configured to apply smoothing and/or neighborhood aggregation when determining f₀(s), for example, to reduce noise and/or fill small gaps.

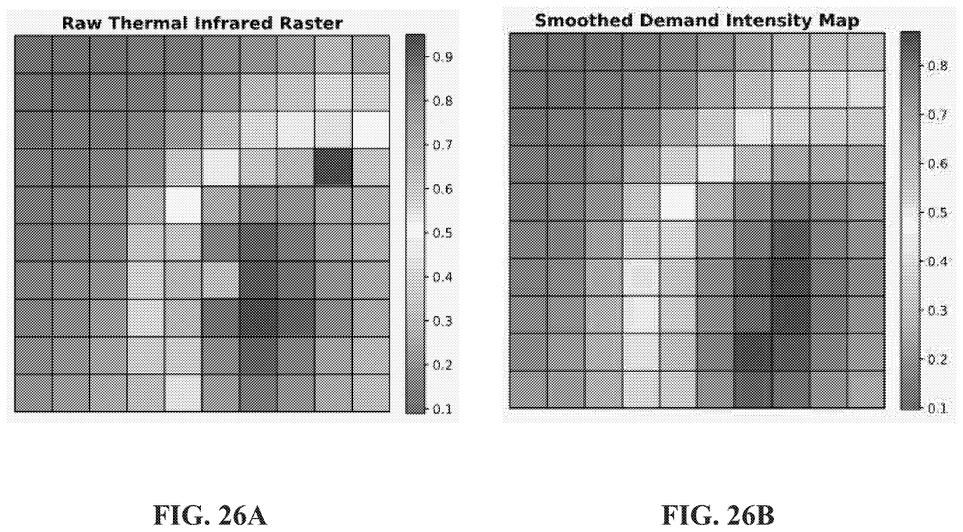

For example, as shown in FIGS. 26A and 26B, an exemplary georeferenced thermal infrared raster received as external data can be converted into a uniform cell demand density map (FIG. 26A), and the converted demand density map may include one or more noisy cells and/or one or more cells that appear as a gap of demand in an otherwise high-demand neighborhood (e.g., area or region) of cells (e.g., cells for which the initially determined level of demand appears inconsistent with one or more surrounding cells). For example, satellite thermal imagery of a wildfire may depict regions (e.g., neighborhoods) of high-temperature or high-value (e.g., demand value) cells which include one or more low-temperature or low-value cells as a result of sensor noise, cloud interference, raster discretization, etc., and the processor(s) 102a can aggregate/smooth cell values over a local neighborhood, such that the low-value (e.g., gap) cells can receive elevated demand intensity consistent with the surrounding demand pattern (e.g., the level of demand of the surrounding cells), as shown in FIG. 27. Alternatively, or additionally, if a neighborhood of low-value cells includes a single or small number of high-value cells, the processor(s) 102a can reduce (e.g., via neighborhood-based smoothing) the value/influence of the high-value cell(s). In other words, the processor(s) 102a can apply a neighborhood-based smooth and/or aggregation to the initial demand density map or current demand density map such that each cell's initial or updated demand value is determined/updated based not only on the cell's own demand value, but on the demand value of nearby cells as well.

In some embodiments, as described above, the demand intensity value (e.g., f₀(s)) for a given uniform cell may then be scaled to a bounded nonnegative field (e.g., scaled between 0 and 1), such that high values can indicate higher service demand and total mass can be controlled. For example, a scaled demand density value (e.g., f(s)) can be determined as:

$$f ( s ) = \frac{{f}_{0} ( s )}{{\sum }_{u ∈ Q} {f}_{0} ( s ) + ϵ}$$

In some embodiments, the processor(s) 102a can be configured to apply feasibility constraints, such as enforcing exclusion zones and/or domain limitations, when determining the scaled demand density value f(s). For example, in some embodiments, the processor(s) 102a may set f(s)=0 for uniform cells whose location(s) is outside of the operating zone P and/or is determined to be a location located within an exclusion zone, such as a no-fly zone (e.g., in the case of UAVs). In some embodiments, feasibility or other region-specific or location-specific restrictions, conditions, constraints, etc., may be addressed by the system in a separate step or process carried out by the processor(s) 102a, for example, in an unmanned vehicle assignment process and/or an unmanned vehicle feasible path determination, as discussed below.

Once the scaled demand value f(s) is determined for each uniform cell location(s), the processor(s) 102a can generate and/or output a base demand density map including the scaled demand density value f(s) for each uniform cell of the uniform cell grid aligned over the operating region P. In some embodiments, the base demand density map may be generated based on the scaled demand density values (f(s)) of a single layer (e.g., mask/grid) of the coordinate map including external data. In other words, in some embodiments, only one external data source 106 (e.g., satellite imagery) may be available, such that the coordinate map may include a single layer (e.g., aligned grid/mask), and the processor(s) 102a may generate the base demand density map based on the scaled demand density values f(s) determined for each uniform cell of the single layer.

In some embodiments, as described above, the system 100 can include a plurality of external data sources 106, such that the coordinate map can include a plurality of layers (e.g., aligned grids and/or masks) each including external data from a different external data source 106. The processor(s) 102a can determine the scaled demand density value f(s) for each uniform cell of each individual layer, for example determine the scaled demand density value f(s) for each uniform cell based on the pixel intensity value(s) contained within said uniform cell, and determine the scaled demand density value f(s) for each uniform cell based on point data corresponding with said uniform cell (e.g., the number of incident reports received for the area within said uniform cell). To generate/output the base demand density map, the processor(s) 102a can combine, aggregate, etc., each scaled demand density value f(s) of each layer (e.g., aligned grid/mask) for a given uniform cell to obtain a total scaled demand density value f(s) of the uniform cell.

For example, in some embodiments, the external data sources 106 of the system 100 can include a satellite imaging source and an incident report source, which provide image data and point data, respectively, to the system 100 for determining demand density values. As described above, and not repeated here in the interest of brevity, the processor(s) 102a can determine a scaled demand density value f(s) for each uniform cell in the image data layer and a scaled demand density value f(s) for each uniform cell in the point data layer. The processor(s) 102a can combine (e.g., via mathematical operations) the scaled demand density value f(s) for a given uniform cell from each layer to determine the total scaled demand density of said uniform cell, which may also be referred to as a base demand density value f(s). That is, the base demand density value f(s) for a given uniform cell can be an initial total value of demand density for the uniform cell that is determined based on a combination of the scaled demand density values that are determined for the uniform cell in each individual external data source layer.

In some embodiments, the processor(s) 102a can be configured to determine the base demand density value f(s) for a uniform cell by performing a weighted combination of all scaled demand density values determined for the uniform cell (e.g., the scaled demand density value for the uniform cell in each layer). Referring to the example above, in which the coordinate map has an image data layer (e.g., aligned grid/mask) and a point data layer, the processors 102a may weight the scaled demand density value f(s) determined in one or more layers (e.g., determined in the image data layer) to prioritize (e.g., prioritize in the determination of the base demand density value f(s)) the scaled demand density value f(s) determined in the one or more layers (e.g., the image data layer) over the demand density value f(s) determined in one or more different layers (e.g., the point data layer).

The processor(s) 102a can generate (e.g., output) a base demand density map 112 including a base demand density value f(s) for each uniform cell in the operating region P, the base demand density f(s) determined based on a combination of each scaled demand density value f(s) determined for a given uniform cell (e.g., the scaled demand density f(s) determined in each layer for the uniform cell). In some embodiments, the system 100 can be configured to update the base demand density map 112 (e.g., via execution of code by the processor(s) 102a) based on mission data. In some embodiments, mission data can include mission command data, such as priority objectives, protected assets, service requirements, etc., unmanned vehicle status and/or operational data, such as current position, altitude, power/battery level, sensor payload, communication range limits, speed, range, endurance, sensor footprint, minimum separation distance, etc. It should be understood that the above is merely exemplary and the mission data can include any suitable mission command data, unmanned vehicle operational/status data, or any other suitable data that may be used for determining an updated demand density value and/or used for tasking the one or more unmanned vehicles.

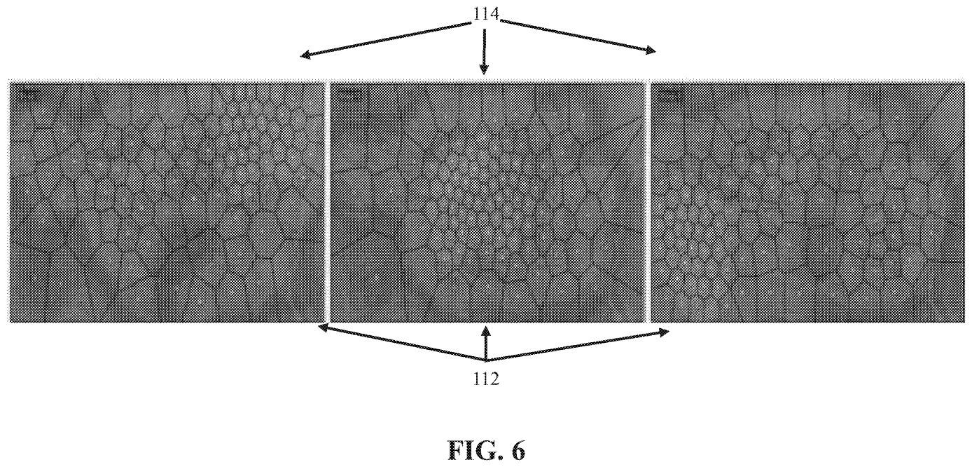

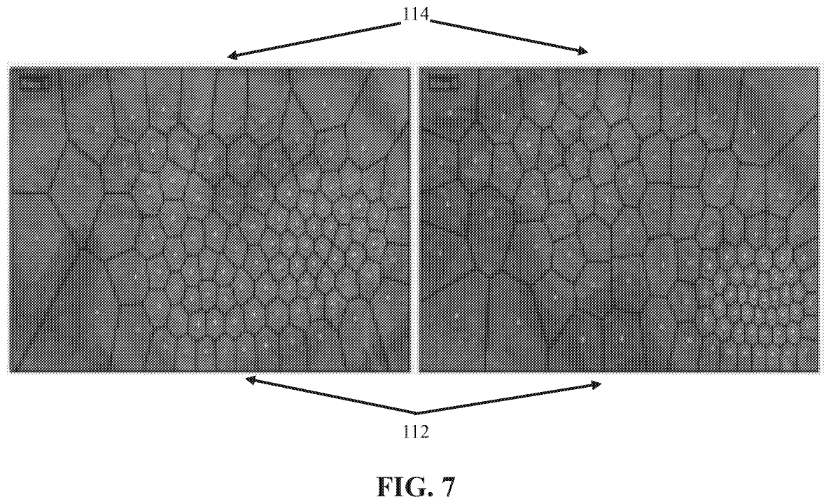

The processor(s) 102a can receive, acquire, and/or access mission data, such as from a mission command center/device (e.g., a mission command computing device 102), from one or more of the unmanned vehicles 104, etc., as input data and can perform one or more mathematical operations or processes using the input data (e.g., mission data) to update the base and/or current demand density values of one or more locations(s) of the demand density map 112 based on the mission data. In some embodiments, the demand density map 112 can be updated on a predetermined interval, such as every 10 seconds, every 30 seconds, every minute, etc., such that dynamically changing levels and/or locations of demand may be factored into the deployment of one or more unmanned vehicles 104, as described below. For example, FIGS. 6, 7, and 17 depict a series of demand density maps 112 depicting a dynamic spatiotemporal demand as it evolves over time. In some embodiments, the processor(s) 102a can update the base demand density map 112 based on mission data and/or external data, such as region-specific conditions, constraints, restrictions, etc., to generate an updated demand density map 112. In some embodiments, the processor(s) 102a can update a previously updated demand density map 112 to further update the current demand density map 112. For example, the processor(s) 102a can update the base demand density values of one or more locations(s) in the base demand density map 112 to emphasize (e.g., increase the base demand value for) one or more locations within the geographic region P that can realistically be served (e.g., physically reached) by the plurality 101 of unmanned vehicles 104.

In some embodiments, the processor(s) 102a may determine one or more weights, based on mission data and/or external data relating to location-based service restrictions (e.g., no-fly zones, restricted areas, protected zones, etc.). Upon determination of a weight for each location(s), the processor(s) 102a can update the current (e.g., base) demand density value f(s) for each location(s) based on the weight calculated for a given location(s), for example, by multiplying the current (e.g., base) demand density f(s) by the weight value to obtain an updated demand density value f(s). In some embodiments, the demand density map can include one or more feasibility layers (e.g., aligned grids or masks) including a feasibility value for each location determined based on the external and/or mission data (e.g., restricted area data). For example, the feasibility layer may contain a value of 0 for each location within operating region P that is located in a restricted area, and a value of 1 for each location within operating region P that is located within a non-restricted (e.g., permissible) area. It should be understood that the feasibility values contained within the one or more feasibility layers do not typically affect the demand value at a given location, and thus, location-based restrictions/constraints may be represented by both a demand mask (e.g., locations inside a restricted area are determined to have 0 total demand) as well as a feasibility layer (e.g., mask or grid), which may be used in the iterative optimization of target deployment locations and/or travel trajectory determination, as described in further detail below.

In some embodiments, the processor(s) 102a can update the current demand density value f(s) for each of one or more locations(s) based on mission data that can include a focus definition transmitted from a mission command to the computing device 102. The focus definition can include, for example, a focus region (e.g., a polygon region including a plurality of locations(s)) and/or specific target locations (e.g., s₁, s₂, s₃, etc.) and a priority factor value. The processor(s) 102a can determine a weight based on the priority factor value and can update the current demand density value f(s) (e.g., base demand density value or previously updated demand density value) for each location(s) that is within the focus region and/or targeted based on the determined priority factor weight, for example, by multiplying the weight by the current demand density level to obtain an updated demand density value f(s). It should be understood that the above are merely examples of how a base and/or current demand density value for each location(s) may be updated, and that the process(es) of updating the base and/or current demand density values f(s) for each location(s) may depend on the particular application in which the system is implemented, the available external and/or mission data, the type of unmanned vehicles, etc.

In some embodiments, the processor(s) 102a can be configured to update the current demand density values of the demand density map 112 based on a predetermined time horizon interval value. For example, the processor(s) 102a can be configured to receive and/or acquire external data and/or mission data on periodic checkpoint intervals, for example, every 10 seconds, and to update the demand density map 112 based on the received external and/or mission data at each checkpoint interval. Accordingly, the system 100 can dynamically adjust deployment of the plurality 101 of unmanned vehicles 104 in response to heterogenous spatiotemporally dynamic levels of demand.

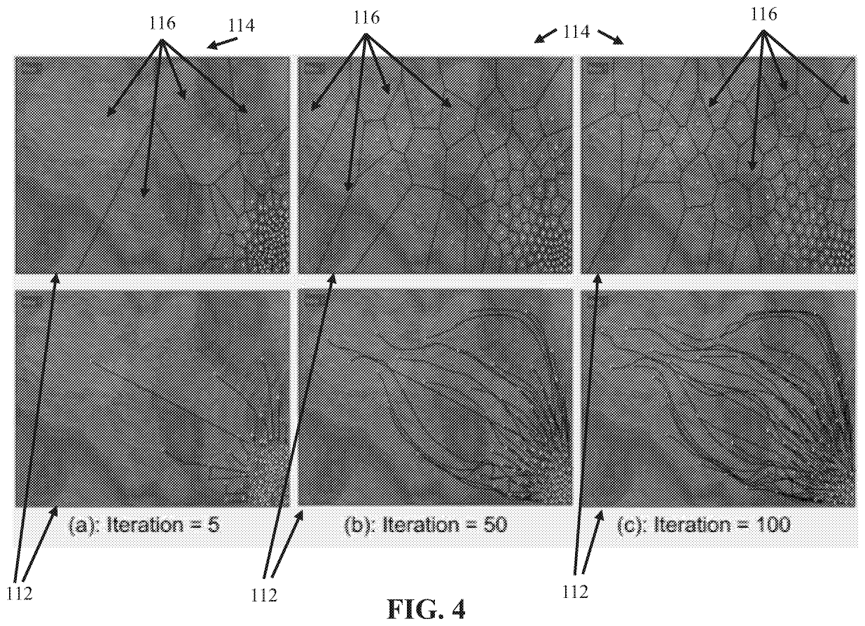

Upon the generation of a base demand density map 112 or the generation of an updated demand density map 112, the processor(s) 102a can generate an initial Voronoi tessellation 114 including a plurality of initial Voronoi coverage areas 116 Vᵢ (e.g., polygons), as depicted in FIGS. 4-7 and 22A-24B. In some embodiments, the initial Voronoi tessellation 114 can be generated with a greedy initialization procedure. For example, the processor(s) 102a can determine/place initial target deployment locations for each unmanned vehicle 104 of the plurality 104, using a greedy strategy. In some embodiments, the initial target deployment locations can be centroids and may be determined/placed one at a time, beginning with a first centroid determined as the demand-weighted center of mass of the demand density map (e.g., the demand-weighted center of operating region P). The processor(s) 102a can generate a partial Voronoi tessellation 114, where the determination/placement of each additional centroid (e.g., initial target deployment location) can induce a new Voronoi coverage region 116 (e.g., polygon).

After determination/placement of the first demand-weighted centroid (e.g., the demand-weighted center of mass of operating region P), a Voronoi coverage region 116 can be generated based on the first demand-weighted centroid. For example, the Voronoi coverage region 116 induced by the first demand-weighted centroid can include the operating region P. The processor(s) 102a can then determine/place a second centroid within the Voronoi coverage region 116 (e.g., place at a randomly selected location s within the Voronoi coverage region), and can generate a second Voronoi coverage region 116 based on the second centroid. The processor(s) 102a can, at each determination/placement of a new centroid (e.g., target deployment location), determine among the existing Voronoi coverage regions 116 (e.g., Voronoi regions induced by previously determined centroids) the Voronoi coverage region 116 having the largest total demand mass, and can determine/place a new centroid therein, for example, at a randomly selected location.

After each new centroid (e.g., initial target deployment location) is placed/determined, the Voronoi tessellation 114 (e.g., a partial Voronoi tessellation comprising the coverage regions of the previously determined/placed centroids) can be recomputed and the newly added centroid(s) can be iteratively adjusted. In some embodiments, the processor(s) 102a can repeat the process of determining/placing centroids until a stopping criteria has been met. For example, the process of determining/placing centroids and generating Voronoi coverage regions 116 for each centroid can be repeated until one Voronoi coverage region 116 exists for each unmanned vehicle 104 of the plurality 101.

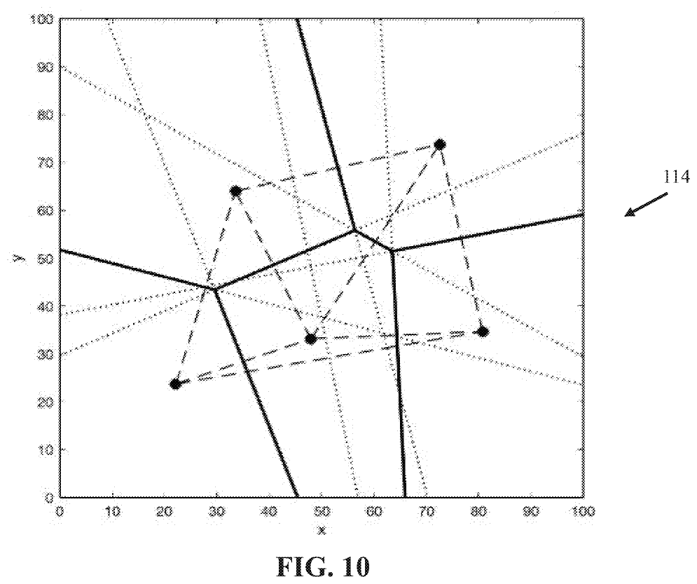

In some embodiments, once a centroid (e.g., target deployment location) for each unmanned vehicle 104 of the plurality of 101 has been determined/placed, the processor(s) 102a can refine the Voronoi tessellation 116 induced by the centroids to generate an initial Voronoi tessellation 116. For example, the initial Voronoi tessellation can be geometrically constructed such that each Voronoi region can contain all the spatial locations (e.g., locations s) closer to its associated centroid than to any other centroid. In some embodiments, the boundaries of the Voronoi tessellation (e.g., boundaries of individual Voronoi coverage regions 116) can be formed by perpendicular bisectors between neighboring centroid pairs, as depicted in FIG. 10. It should be understood that the above is merely exemplary and that the processor(s) 102a can partition the current density map into any type and/or number of regions and/or can generate any suitable type of Voronoi tessellation 114.

After the generation of the initial Voronoi tessellation 114 and the initial target deployment locations (e.g., centroids), the processor(s) 102a can determine an optimized target deployment location within each Voronoi coverage region 116 for deploying a given unmanned vehicle 104 to. In some embodiments, the processor(s) 102a can provide the current demand density as a function of location (e.g., f(s)) for each location s within a given Voronoi coverage region 116 and the current (e.g., initial or updated) target deployment location within each Voronoi coverage region 116 to a cost function to determine the optimized target deployment location located within each Voronoi coverage region 116. For example, in some embodiments, the cost function can be written as:

$$J ( μ ) = {\sum }_{i = 1}^{K} {\int }_{s ∈ {V}_{i}} f ( s ) {‖ s - {μ}_{i} ‖}^{2} d s$$

where f(s) is the current demand density value for a given location(s), uᵢ is the current target deployment location, K is the total number of unmanned vehicles 104 in the plurality 101, Vᵢ is a Voronoi coverage region 116 including one or more locations(s), and where J(u) is the resulting total demand weighted cost of serving/satisfying the demand at each location(s) within the corresponding coverage region 116 summed over all K regions (e.g., Vᵢ for i=1, summed over all V regions from 1 to K). It should be understood that in the context of this disclosure μᵢ and μᵢ may be used interchangeably.

The cost function assigns a cost to serving demand at each location s∈Vᵢ that is proportional to the product of the demand density f(s) and the squared distance ∥s−μᵢ∥² Therefore, when a given μᵢ (e.g., target deployment location) is far from locations (e.g., s) with high demand density within its assigned region 116, for example when it is hovering over locations with little or no demand density while other high-demand density locations exist elsewhere in its region, the gradient output of the cost function will indicate that a higher cost value is associated with servicing demand within the assigned region 116. As described above, the total fleet objective can sum this demand weighted distance cost over all K regions, so that updates made based on the summed demand-weighted cost account (e.g., updates to unmanned vehicle locations, as described below) for the overall fleet level deployment (e.g., deployment of the plurality 101) rather than optimizing a single unmanned vehicle 104 in isolation.

In some embodiments, the processor(s) 102a can iteratively update the target deployment locations(s) of each Voronoi coverage region 116 using the cost function. That is, the processor(s) 102a can provide the current demand value as a function of location for each location s within a given coverage region 116 and the target deployment location uᵢ assigned to the given coverage region 116, for each coverage region 116 within the Voronoi tessellation 114, to the cost function (e.g., objective) to generate a gradient output indicating the direction in which moving each target deployment location uᵢ reduces the demand-weighted cost (e.g., output of the cost function).

The gradient can indicate the direction (e.g., navigation direction) in which moving uᵢ could or would rapidly decrease the value of J(u), and the processor(s) 102a can update each target deployment location uᵢ in the direction that reduces the demand-weighted cost (e.g., the outcome of the cost function). For example, the processor(s) 102a can store the initial and/or current target deployment locations in memory 102b prior to providing them to the cost function objective, and can iteratively update the target deployment locations stored in the memory 102b based on iterative gradient outcomes of the cost function. In some embodiments, for each iteration of the cost function, the processor(s) 102a may update (e.g., in memory 102b) each uᵢ to move each uᵢ (e.g., adjust the value of each uᵢ) in the direction indicated by the cost function. In some embodiments, the processor(s) 102a may update each target deployment location uᵢ based on the cost function gradient and with a step or distance magnitude that is proportional to the magnitude of the gradient.

In some embodiments, prior to updating each location uᵢ stored in the memory 102b based on a gradient output of the cost function, the processor(s) 102a can determine whether moving a given target deployment location in the direction indicated by the cost function gradient would result in said target deployment location being placed in a location that is subject to location-based restrictions or constraints (e.g., no-fly zone). For example, each restricted region can be represented by a conservative convex envelope (e.g., in the feasibility layer). When a given updated location uᵢ (e.g., an updated target deployment location uᵢ determined by moving the current target deployment location uᵢ in the direction and distance determined by the cost function gradient) is determined by the cost function, the processor(s) 102a can determine, based on the feasibility layer, if the updated target deployment location would be placed in a restricted region. If it is determined that a given updated target deployment location would be located in a restricted region, the processor(s) 120a can execute a projection operator to automatically map the updated target deployment location to the nearest boundary location of the restricted area (e.g., conservative convex envelope) and apply a small offset, such that each updated target deployment location can maintain strict feasibility throughout the iterative updating.

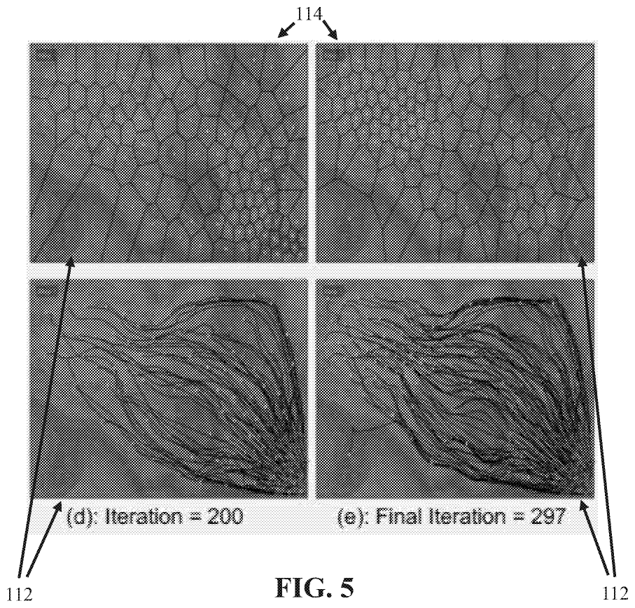

Upon the updating of each location uᵢ (e.g., in the memory 102b), the processor(s) 102a can generate an updated Voronoi tessellation 114 based on the updated uᵢ locations. For example, the Voronoi tessellation 114 can be updated (e.g., in memory 102b) using the geometric construction process described above, such that one or more Voronoi coverage regions 116 can be updated based on the updated location uᵢ. In some embodiments, the processor(s) 102a can update each of the target deployment locations uᵢ (e.g., in the memory 102b) based on the gradient of the cost function, and can update the Voronoi tessellation 114 (e.g., in the memory 102b) based on the updated target deployment locations uᵢ after each iteration of the cost function, such that the target deployment locations uᵢ and the Voronoi tessellation 114 gradually evolve with each iteration of the cost function until convergence is achieved, as depicted in FIGS. 4-5.

In some embodiments, the processor(s) 102a can iteratively repeat the execution of the cost function, updating of the target deployment locations, and updating/recomputing of the Voronoi tessellation 114 based on the updated target deployment locations until it has been determined that convergence has been achieved, such that each target deployment location uᵢ determined during the iteration in which convergence is achieved is an optimized target deployment location. In some embodiments, convergence can be determined when optimization of the target deployment locations has stabilized. For example, in some embodiments, the processor(s) 102a can evaluate the output of the cost function to determine a change in the total cost between successive iterations and/or to determine the norm of the output gradient. In some embodiments, convergence can be determined when it is determined that the change in cost between successive iterations of the cost function falls below a predetermined threshold and/or when the norm of the gradient output of the cost function falls below a predetermined threshold. It should be understood that the above is an exemplary way of determining convergence and that any suitable processes to determine convergence can be used.

As described above, physically restricted areas within the operating region P can be represented in the demand density map with a value of zero demand (e.g., via a demand-value-mask), such that a given optimized target deployment location will not be located within a restricted area. However, a value of 0 demand will not necessarily prevent the determination of a pathway trajectory for a given unmanned vehicle to travel to its optimized deployment location by passing through one or more locations with 0 demand value. Accordingly, in some embodiments, after the generation/determination of the optimized target deployment locations and the updated Voronoi tessellation, the processor(s) 102a can determine a feasible region F within the operating region P based on one or more location-based restrictions and/or constraints. For example, restricted areas (e.g., no-fly-zones, protected areas, etc.), location-based altitude limits, etc., determined based on, for example, external data and/or mission data received and/or acquired by the processor(s) 102a.

In some embodiments, once the optimized target deployment locations have been determined for each Voronoi region 116, the processor(s) 102a can output the optimized target deployment locations as a set of unordered candidate deployment locations, each of which can be assigned to a given unmanned vehicle 104 of the plurality 101. The processor(s) 102a can determine an executable trajectory for each unmanned vehicle to reach each optimized target deployment location from its current physical location, for example, using a general-purpose pathfinding algorithm, such as an obstacle-aware A* search. That is, based on the current physical location of each unmanned vehicle 104 (e.g., as determined from mission/operational data) and the optimized target deployment locations, the A* search can determine the shortest feasible planned path from each current unmanned vehicle location to each optimized target deployment location, and can determine an executable trajectory for each unmanned vehicle to follow along its assigned planned path, as further described below.

The obstacle-aware A* search can output a cost matrix including a cost associated with one or more cost variables, such as a physical distance cost, an energy usage cost, a traversal time cost, and/or any other suitable cost variable, such that a cost for each unmanned vehicle to reach each optimized target deployment location is determined. For example, the A* search can determine the shortest feasible trajectory path (e.g., least physical distance cost) from a given unmanned vehicle 104 to a given optimized target deployment location (e.g., uᵢ) for each possible combination of unmanned vehicles 104 and optimized target deployment locations. For example, the A* search can systematically (e.g., cell by cell) search, based on the conservative convex envelopes of the feasibility layer, through all feasible cell locations, while ignoring the unfeasible cell locations, to determine the shortest feasible trajectory pathway for each unmanned vehicle 104 to reach each optimized target deployment location.

The processor(s) 102a can, upon generation of the A* search cost matrix, assign each unmanned vehicle 104 of the plurality 101 to the optimized target deployment location of one or more of the Voronoi coverage regions 116, for example, using a Hungarian algorithm. In an exemplary embodiment, each unmanned vehicle 104 can be assigned to a different optimized target deployment location, each in a different Voronoi coverage region 116. In some embodiments, two or more unmanned vehicles 104 may be assigned to a single Voronoi coverage region 116. The Hungarian algorithm can assign each unmanned vehicle to one optimized target deployment location based on the lowest total cost of assigning an unmanned vehicle to each optimized target deployment location, as determined by the cost matrix output by the A* search.

In some embodiments, one or more unmanned vehicles may be assigned to a given Voronoi coverage region 116 and/or optimized target deployment location based on a location-based capability requirement. For example, one or more unmanned vehicles 104 of the plurality 101 may have different capabilities, for example, some unmanned vehicles may carry a special payload (e.g., fire suppressant) that may be required at one or more Voronoi coverage regions 116. That is, the processor(s) 102a can determine, for example, based on mission data, operator input data, payload requirements, or other service-specific region labels that require a specific capability. Such capability requirement(s) can be converted into a capabilities layer (e.g., grid or mask) aligned over the demand density map, and the capabilities layer data can dictate the assignment of one or more unmanned vehicles based on their capabilities.

For example, within the context of wildfire monitoring, satellite image data may depict dense smoke in a particular region, which can be determined by the processor(s) 102a to require a specific capability (e.g., fire suppressant). This region can be marked in the capabilities layer and, as such, can be evaluate during the assignment process, such that one or more unmanned vehicles having the required capability can be assigned to the region having the requirement. In some embodiments, capability-specific unmanned vehicles can be bound the corresponding region (e.g., via imposition of location bounds, other optimization constraints, etc.) during the Voronoi-based optimization, such that the creation and updating of the Voronoi tessellation can be performed subject to those capability-based assignment constraints.

In some embodiments, operational constraints/restrictions (e.g., based on external data, mission data, etc.) may be implemented by the processor(s) 102a to determine an executable trajectory for each unmanned vehicle 104. That is, each planned path (e.g., each planned path from a given unmanned vehicle to a given optimized target deployment location) included in the cost matrix output by the A* search can be evaluated based on operational constraints/restrictions to determine an executable trajectory for each unmanned vehicle to follow its assigned planned path, while satisfying one or more constraints and/or restrictions.

For example, a path length of a planned path determined by the A* search and assigned to a given unmanned vehicle by the Hungarian algorithm can be evaluated based on one or more operational restrictions or constraints for said given unmanned vehicle, such as the maximum distance allowed by the remaining battery level of the given unmanned vehicle and/or a maximum distance allowed by the maximum speed of the given unmanned vehicle within a given time period (e.g., within a predetermined checkpoint time period, as described further in detail below). If it is determined that the given unmanned vehicle is incapable of completing its entire planned path to its assigned optimized target deployment location, the processor(s) 102a may generate an executable trajectory for the given unmanned vehicle such that the unmanned vehicle moves along its planned path for the maximum distance permitted by one or more constraints/restrictions. In some embodiments, the processor(s) 102a may generate an executable trajectory for one or more unmanned vehicles that directs each unmanned vehicle to not move from its current location (e.g., not to move any distance along its planned path) based on the one or more operational constraints/conditions. It should be understood that the above is merely exemplary and that the determination of an executable trajectory for one or more unmanned vehicles can be based on any suitable operational constraints/conditions that may affect the unmanned vehicle's ability to execute its determined executable trajectory.

In some embodiments, the processor(s) 102a can generate control data (e.g., control signals) for each unmanned vehicle 104 of the plurality 101 based on the determined executable trajectory for each unmanned vehicle. The computing device 102 can transmit the control data to each unmanned vehicle to cause one or more unmanned vehicles to move along its assigned executable trajectory. In some embodiments, the computing device 102 may transmit the executable trajectory for one or more unmanned vehicles to the corresponding unmanned vehicle and the corresponding unmanned vehicle may generate (e.g., via the processor(s) 104a) the control signals. In some embodiments, the processor(s) 102a may transmit the control data and/or executable trajectory for each of the unmanned vehicles 104 to one or more unmanned vehicles 104 of the plurality 101 and the one or more unmanned vehicles 104 which receive the control data and/or executable trajectories can transmit the control data and/or executable trajectories to one or more additional unmanned vehicles 104 of the plurality 101, for example, as a communication relay of the control data transmitted by the computing device 102.

In some embodiments, the processor(s) 102a can generate a visual representation of the operating region P showing the current updated Voronoi tessellation, the current and/or target deployment location of each unmanned vehicle, and/or a visual representation of demand (e.g., a visual demand density map 112 depicting the various levels of demand with the current Voronoi tessellation 114 and unmanned vehicle locations overlaid). In some embodiments, the visual representation can be generated during the iterative optimization of target deployment locations, such that the visual representation can include intermediate target deployment locations and/or intermediate Voronoi tessellations. In some embodiments, the visual representation can include the executable trajectories determined by the processor(s) 102a based on the Hungarian-A* search and/or operational constraints/conditions. In some embodiments, the visual representation can be transmitted to a remotely connected (e.g., communicatively connected) computing device 102, for example, at a mission command facility for user (e.g., operator) guidance and/or dispatch of the unmanned vehicles 104. It should be understood that the above is merely exemplary, and that any suitable type of visual representation can be generated, and further, that the visual representation can be transmitted to any suitable device, server, database, cloud network, etc.

In some embodiments, the system 100 can be configured to operate according to a checkpoint-based framework for adaptive and dynamic deployment of the plurality 101 of unmanned vehicles 104. In such embodiments, the deployment optimization process can be discretized over a mission time horizon into a sequence of checkpoint intervals, each of a predetermined duration (e.g., T₀ seconds). The mission time horizon [0, T] can thus be partitioned into N intervals, where N=T/T₀, and each checkpoint can be indexed by t=0, 1, . . . , N, corresponding to physical times tT₀. At each checkpoint, the system 100 can perform the sequence of demand determination, target deployment location optimization, unmanned vehicle assignment, and executable trajectory generation processes and procedures described above, thereby enabling the plurality 101 of unmanned vehicles 104 to continually adapt to evolving spatiotemporal demand distributions and operational constraints.

At each checkpoint t, the processor(s) 102a can access or generate an updated demand density map fᵢ(s), where fᵢ(s) may represent the demand density at spatial location s∈P at time tT₀. The updated demand density map may be determined based on external data, mission data, and/or sensor data as previously described, and can be used to determine the demand field (e.g., generate the demand density map) for the current checkpoint. The processor(s) 102a can then determine the current deployment configuration x[t]={x₁[t], . . . , x_M[t]}, where xᵢ[t] can represent the location of unmanned vehicle i at checkpoint t. Based on these locations, the system can generate a Voronoi tessellation 116 {Vᵢ(x[t])} over the operating region P, partitioning the region into coverage areas associated with each unmanned vehicle 104, as described above.

For each checkpoint t, the system 100 can compute a coverage cost function Cₜ(x[t]) that quantifies the total demand-weighted squared distance between each unmanned vehicle and the points within its corresponding Voronoi coverage region. The coverage cost function may be expressed as:

$${C}_{t} ( x [ t ] ) = {\sum }_{i = 1}^{M} {\int }_{{v}_{i ( x [ t ] )}} {‖ s - {x}_{i} [ t ] ‖}^{2} {f}_{t} ( s ) d s$$

where M can be the number of unmanned vehicles, Vᵢ(x[t]) can be the Voronoi region for vehicle i, and fₜ(s) can be the demand density at location s at checkpoint t. The objective at each checkpoint can be to minimize Cₜ(x[t]) by iteratively updating the target deployment locations until convergence is achieved.

To optimize the target deployment locations, the processor(s) 102a can iteratively update the target deployment location of each unmanned vehicle by moving it toward the demand-weighted centroid of its Voronoi region. The demand-weighted centroid ζᵢ(x[t]) for region Vᵢ(x[t]) may be given by:

$${ζ}_{i} ( x [ t ] ) {=}^{△} \frac{{\int }_{{V}_{i} ( x [ t ] )} s {f}_{t} ( s ) d s}{{\int }_{{V}_{i} ( x [ t ] )} {f}_{t} ( s ) d s}$$

The gradient of the coverage cost function with respect to xᵢ[t] can be computed as:

$$\frac{\partial {C}_{t}}{\partial {x}_{i} [ t ]} = 2 {M}_{i} ( x [ t ] ) ( {x}_{i} [ t ] - {ζ}_{i} ( x [ t ] ) )$$

$$where :$$

$${M}_{i} ( x [ t ] ) {=}^{△} {\int }_{{V}_{i} ( x [ t ] )} {f}_{t} ( s ) d s$$

is the demand of region Vᵢ(x[t]). Each unmanned vehicle's target deployment location can be updated according to:

$${x}_{i} [ t ] ← {x}_{i} [ t ] - α \frac{\partial {C}_{t}}{\partial {x}_{i} [ t ]}$$

where α can be a step size parameter, e.g., α>0. This process can be repeated until convergence or until a predetermined number of iterations have been completed at the checkpoint.

In some embodiments, after the iterative optimization of target deployment locations is completed, geographic and/or operational restrictions, such as restricted areas or no-fly zones, can be enforced as feasibility constraints by defining a feasible region as:

$$ℱ {=}^{△} 𝒫 ∖ {{⋃}_{h = 1}}^{H} {ℋ}_{h}$$

where each [symbol] ₕ denotes a restricted region. The demand density fₜ(s) can be set to zero for all s∈F. During the iterative optimization process, if a candidate position for an unmanned vehicle falls within a restricted region or its conservative convex envelope, the system can apply a projection operator Π_{F}(·) to map the candidate position to a feasible boundary location, optionally with a small offset to maintain strict feasibility. In this way, the optimization can be carried out subject to the feasible region F, such that deployment locations remain feasible throughout the update process.

Upon completion of the optimization step at each checkpoint, the system 100 can produce a set of M target deployment locations for the plurality 101 of unmanned vehicles 104. The assignment of unmanned vehicles to these target locations can be performed by constructing a cost matrix, where each entry can represent the cost of a feasible path from a current UAV location to a target deployment location. The cost for each unmanned vehicle-target pair can be determined using an obstacle-aware A* search algorithm, which can compute the shortest feasible path within the feasible region F, avoiding restricted areas as encoded in the feasibility layer. The resulting path lengths may populate the cost matrix for assignment.

The processor(s) 102a can then execute an assignment algorithm, such as the Hungarian algorithm, to assign each unmanned vehicle to a target deployment location in a manner that minimizes the total assignment cost across the plurality 101 of unmanned vehicle 104. The assignment can be performed at each checkpoint, and the assignment can be invariant to permutations of the unmanned vehicles, treating the set of targets as unordered. The Hungarian algorithm can ensure that each unmanned vehicle is assigned to a unique target location, such that the sum of the feasible path costs is minimized for the entire fleet.

After assignment, the system 100 can determine an executable trajectory for each unmanned vehicle based on operational constraints, such as maximum speed and remaining battery (or energy) capacity. For each assigned unmanned vehicle, the system can compute the maximum travel distance permitted during the checkpoint interval, which may be limited by the UAV's maximum speed v_max and/or remaining battery range D_max. If the path length to the assigned target exceeds the allowed travel distance for the interval, the system can direct the unmanned vehicle to travel along the planned path for the maximum allowable distance; otherwise, the vehicle can proceed directly to the target location. If the permissible travel distance is zero (e.g., due to depleted battery or speed constraints), the unmanned vehicle can remain at its current location and continue to provide coverage over its local neighborhood.

In some embodiments, the checkpoint framework can further support reliability modeling and backup dispatch of unmanned vehicles. The processor(s) 102a can assess the probability of UAV failures at each checkpoint based on operational age and reliability models (e.g., Weibull distribution). If one or more UAVs are determined to have failed during a checkpoint interval, the system can dispatch backup UAVs from a depot location to replace failed units. The initial positions of backup UAVs can be set to the depot location, and their operational status can be reset. The system can then proceed with the optimization, assignment, and trajectory execution steps as described above, incorporating the backup UAVs into the fleet for subsequent checkpoints.

The checkpoint-based deployment process described herein can enable the system 100 to provide continuous, adaptive, and resilient tasking of unmanned vehicles in environments with dynamic spatiotemporal demand, operational constraints, and reliability considerations. By discretizing the mission horizon into checkpoint intervals and performing optimization, assignment, and trajectory planning at each checkpoint, the system can maintain effective coverage, minimize operational costs, and respond to failures and environmental changes in real-time or near-real-time.

In some embodiments, the system 100 can be configured to model and manage the reliability of the plurality 101 of unmanned vehicles 104 operating over extended mission horizons. For example, the processor(s) 102a can utilize reliability models, such as the Weibull distribution, to estimate the probability of failure for each unmanned vehicle 104 based on its operational age and other relevant parameters. For example, the processor(s) 102a can track the operational age αᵢ of each unmanned vehicle i, and can compute a reliability function R(αᵢ) that estimates the likelihood that the unmanned vehicle will remain operational for a given time period. The reliability function can be expressed as:

$$R ( {a}_{i} ) = exp ( - {( \frac{{a}_{i}}{λ} )}^{k} )$$

where λ can be a scale parameter and k can be a shape parameter of the Weibull distribution. The processor(s) 102a can update the operational age of each unmanned vehicle at each checkpoint interval, and can utilize the reliability function to assess the conditional probability of failure for each vehicle over the upcoming checkpoint interval.

At each checkpoint, the processor(s) 102a can evaluate the failure risk for each unmanned vehicle by computing the conditional probability that a given unmanned vehicle 104 will fail during the next interval, based on its current operational age. The conditional probability of failure for unmanned vehicle i at checkpoint t can be computed as:

$${p}_{f , i} [ t ] {=}^{△} 1 - \frac{R ( {a}_{i} [ t ] + {T}_{0} )}{R ( {a}_{i} [ t ] )} = 1 - exp ( - [ {( \frac{{a}_{i} [ t ] + {T}_{0}}{λ} )}^{k} - {( \frac{{a}_{i} [ t ]}{λ} )}^{k} ] )$$

where T₀ can represent the duration of the checkpoint interval. The processor(s) 102a can utilize this probability to simulate or detect failures, for example, by comparing the computed probability to a randomly generated value or by receiving actual failure data from the unmanned vehicles 104 (e.g., as mission data).

If a failure is detected or simulated for one or more unmanned vehicles during a checkpoint interval, the processor(s) 102a can initiate a backup dispatch procedure. In some embodiments, the system 100 can be configured to maintain a reserve of backup unmanned vehicles stationed at a designated depot location within the feasible region F. Upon detection of a failure, the processor(s) 102a can assign a backup unmanned vehicle to replace each failed vehicle. The initial position of each backup unmanned vehicle can be set to the depot location, and its operational age and cumulative travel distance can be reset to zero. The operational data for the backup unmanned vehicle can be initialized accordingly in the system memory 102b.

Following the backup dispatch, the processor(s) 102a can update the current deployment configuration to include the backup unmanned vehicles and can proceed with the optimization, assignment, and trajectory planning procedures for the next checkpoint as previously described. The backup unmanned vehicles can be incorporated into the fleet and assigned to target deployment locations in the same manner as the other operational vehicles. The checkpoint-based framework can thus enable the system 100 to maintain effective coverage performance and service quality, even in the presence of random or unplanned unmanned vehicle failures.

In some embodiments, the system 100 can further be configured to evaluate the impact of unmanned vehicle failures and backup capacity on overall coverage quality. For example, the processor(s) 102a can monitor a cumulative coverage cost and assess how the deployment of backup unmanned vehicles affects the ability of the plurality 101 to satisfy demand across the operating region P and/or F. The processor(s) 102a can dynamically adjust the number of backup vehicles dispatched at each checkpoint based on observed or predicted failure rates, mission requirements, and resource availability. In some embodiments, the processor(s) 102a can determine that dispatching additional backup vehicles beyond a certain threshold may yield diminishing returns in coverage quality, and can allocate backup resources accordingly to maximize operational efficiency.

By incorporating reliability modeling and backup dispatch into the checkpoint-based deployment process, the system 100 can provide robust and resilient tasking of unmanned vehicles, ensuring continuity of service in dynamic and uncertain operating environments. The integration of probabilistic failure assessment, backup management, and adaptive redeployment can enable the system 100 to maintain high levels of coverage and mission performance, even under adverse or unpredictable conditions.

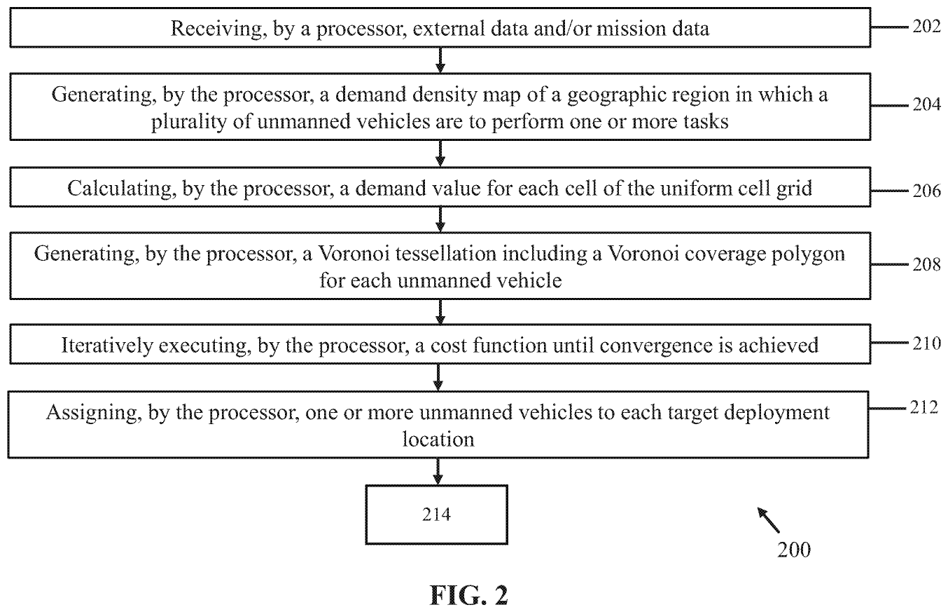

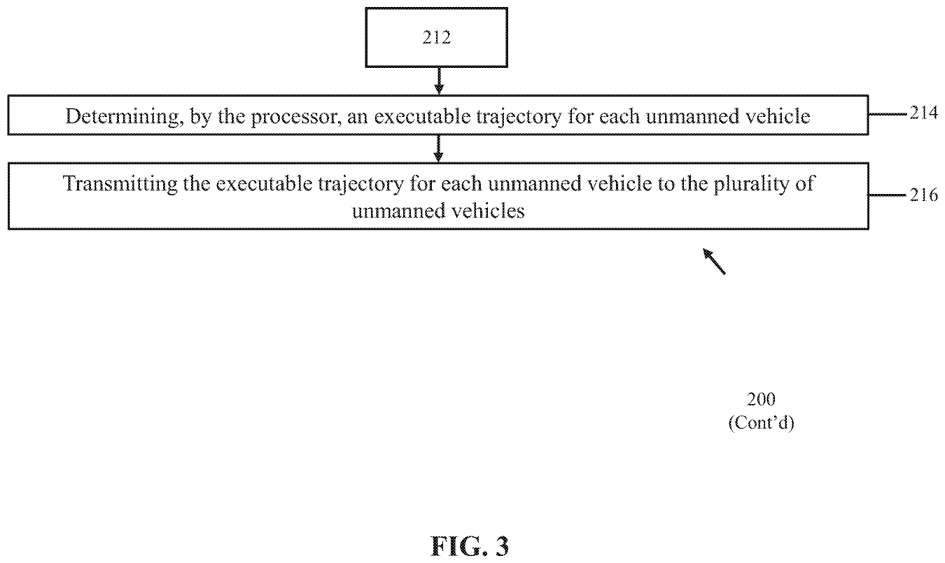

Referring now to FIGS. 2 and 3, an exemplary method for optimized tasking of unmanned vehicles 200 is provided. The method 200 can utilize any of the above-described embodiments, elements, processes, etc., of the optimized system for unmanned tasking 100, the details of which are not repeated here in the interest of brevity. In some embodiments, the method 200 may be performed based on a checkpoint framework, as described above, such that one or more of the method steps described below may be repeated at each checkpoint time interval for the duration of a mission. In some embodiments, each step of the method described below may be performed at each checkpoint time interval.

The method 200 can include a first step 202, receiving, by at least one processor, external data and mission data. As described above, external data can include any suitable type of data generated by one or more external data sources and based on the current operational condition and/or status of an operating region, such as environmental data, and mission data can include any suitable type of data relating to the tasks to be performed by one or more unmanned vehicles and/or relating to an operational status/parameter(s) of one or more of the unmanned vehicles to perform the tasking. In some embodiments, the external data and/or mission data received by the at least one processor can be stored (e.g., by the at least one processor) in a non-transitory computer-readable storage medium (e.g., memory 102b), such that the external and/or mission data may be retrieved, altered, or otherwise interacted with by the at least one processor.

The method 200 can include a second step 204, generating, by the at least one processor, a demand density map defining an operating region in which one or more unmanned vehicles are to perform one or more tasks, the demand density map including a uniform grid of cells (e.g., N×N cells) defined over the operating region in a map coordinate system, where the center of each cell is defined as a location s (e.g., s₁, s₂ . . . s_{N}), each location s being a pair of (x, y) coordinates within the map coordinate system. The method 200 can include a third step 206, converting, by the at least one processor, the received external data into one or more layers aligned over the uniform grid coordinate system, each layer including a mask or a grid generated based on the external data. Each generated layer can be aligned over the uniform grid such that external data received for a specific physical location within the operating region can correspond to said specific physical location in the demand density map coordinate system, e.g., s₁. In some embodiments, the resolution of the uniform grid (e.g., the total number of cells and/or the size of each cell) can be predetermined. In some embodiments, the resolution of the uniform grid can be based on the received external data and/or mission data, for example, such as based on the total number of unmanned vehicles, the size of the operating region, the amount and or type of external data received, etc. In some embodiments, if the resolution and/or the amount of external data contained within a given layer does not match the resolution and/or size of the uniform cell grid, the at least one processor can perform one or more mathematical and/or resampling operations (e.g., interpolation, smoothing, aggregation, etc.), such that each cell of the uniform grid may have a corresponding value.

In some embodiments, each layer (e.g., mask or grid) may be generated based on the type of external data contained within the layer and/or based on the source of the external data. For example, in some embodiments, the at least one processor can generate one layer (e.g., mask or grid) including all external image data (e.g., satellite images), one layer including all point data, one layer including all vector data, etc. In some embodiments, one or more of the layers can include demand value data, as described above, and/or one or more of the layers can include feasibility data (e.g., restricted area data). In some embodiments, the at least one processor can generate one layer (e.g., mask or grid) for each external data source, such that the external data received from one source can be included in one layer, the external data received from a second source can be included in a second, different layer, etc. It should be understood that the above is merely exemplary and that the demand density map generated by the at least one processor can include any number and/or type of layers, masks, grids, etc.

The method 200 can include a fourth step 208, converting each of the external demand-related data values contained within each layer of the demand density map into a demand density representation as a function of location (e.g., a nonnegative demand value for each location). In some embodiments, converting each of the external demand-related data values into a nonnegative demand value can include normalizing and/or scaling, such as min-max scaling, z-score normalization, non-linear transformation, etc., such that the external demand-related data values of each layer of the demand density map can each represent a level of nonnegative demand on the same scale (e.g., a value of demand between 0 and 1). In some embodiments, the method can optionally include a step of, prior to converting the external data values into nonnegative demand values, determining, for each of one or more layers of the demand density map, one or more numeric values based on the external data of the given layer. For example, in some embodiments, the external data can include image data, as described above. In such embodiments, the method can include the step of determining a numeric value for each pixel of the image data (e.g., pixel intensity numeric value, pixel color numeric value, etc.), for example, via image processing algorithms, models, etc.

In some embodiments, the step of converting the external data values to nonnegative demand values can include defining a mask and/or filter based on a predetermined threshold value of the external data values, such that only cells including an external data value above or below the predetermined threshold value are converted to nonnegative demand values. In some embodiments, the value of the difference between the external data value and the predetermined threshold can be converted into a nonnegative demand value, for example, instead of the full value of the external data. In some embodiments, converting the external data values to nonnegative demand values can include setting the nonnegative demand value to 0. For example, if a location s is determined to be outside of the operating region (e.g., the operating region may dynamically change), and/or if the external data at a given location s includes location-based restrictions (e.g., no-fly zones), the nonnegative demand value of said location s can be set to 0, for example. As described above, in some embodiments, location-based restrictions may be represented by a feasibility layer in addition to a demand mask, for example.

The method 200 can include a fifth step 210, generating, by the at least one processor, a base demand density map including a nonnegative demand density field including a nonnegative demand value as a function of location (e.g., f(s)) defined on the uniform cell grid over the operating region. In some embodiments, the step of generating the base demand density map 112 can include combining (e.g., mathematically) each nonnegative demand value corresponding to a given location s for each location s included in the demand density map and/or within the operating region, such that a total nonnegative demand value for each location s can be determined. For example, as described above, the demand density map can include a plurality of layers (e.g., masks and/or grids) each including separate external data values that can each be converted into their own nonnegative demand value, such that a given location s can include a plurality of nonnegative demand values converted from a plurality of external data values.

In some embodiments, the at least one processor can generate the base demand density map such that the total nonnegative demand value of the base demand density map for each location s can be based on a combination (e.g., summary, product, etc.) of each of the converted nonnegative demand values corresponding (e.g., aligned with) a given location s. In some embodiments, the base demand density map can be generated based on a weighted combination of one or more converted nonnegative demand values (e.g., converted from external data values), such that one or more converted nonnegative demand values corresponding to a given location s can have a greater or lesser impact on the total nonnegative demand value for said given location s. For example, in some embodiments, the external data of one layer may be more or less important to the overall determination of demand density, such that the converted nonnegative demand values may be more or less representative of actual demand density, as opposed to the converted nonnegative demand values of other layers, and thus, can be emphasized or de-emphasized in the total demand density value. In some embodiments, the total demand density values for each location s can be normalized and or scaled (e.g., by the at least one processor) such that each total demand density value for each location s is contained within the same range (e.g., 0-1). As described above, in a checkpoint-based framework execution of the method 200, the step 205 can be performed based on current external and/or mission data that is stored and/or acquired (e.g., by the processor(s) 102a) at the time of the current checkpoint.

The method 200 can include a sixth step 212, updating, by the at least one processor, the base demand density map based on the received mission data. In some embodiments, updating the base demand density map based on the received mission data can include determining a demand density weight that is based on the received mission data, and applying said demand density weight to the base demand density value for each location s to update the base demand density value for each location s of the base demand density map. In some embodiments, the mission data can include user input (e.g., mission command) focus definition data, such a specified focus region within the overall operating region or a target location s, and a predetermined priority factor value. The at least one processor can determine a demand density weight based on the predetermined priority factor and apply the determined demand density weight to the current demand value (e.g., base demand value or updated demand value) at each location s (e.g., f(s)) within the specified focus region or target location s.

It should be understood that the above is merely exemplary, and that the step of updating the base or current demand density map can based on mission data and/or external data can be performed by the at least one processor using any suitable mathematical methods and/or processes. For example, in some embodiments, the at least one processor can determine (e.g., calculate) one or more demand density weights based on the mission data and/or external data and apply said density weights to the current demand density value of one or more locations s. In some embodiments, the at least one processor can convert the mission data and/or external data to normalized and/or scaled nonnegative demand values (e.g., normalized and scaled to match the normalization/scaling of the external data converted to generate the base demand density map) and combine the converted nonnegative demand values to the current or base demand density value of one or more locations s.

The method 200 can include a seventh step 214, generating, by the at least one processor, an initial Voronoi tessellation including a plurality of initial Voronoi coverage regions Vᵢ (e.g., Voronoi polygon) aligned over the demand density map (e.g., base/current/updated demand density map). The step of generating an initial Voronoi tessellation, for example, iteratively determining demand-weighted centroids, recomputing the Voronoi tessellation for each added centroid, and recomputing the initial Voronoi tessellation once a centroid for each unmanned vehicle 104 of the plurality has been determined, etc., is described in detail above and is not repeated here in the interest of brevity. As described above, in a checkpoint-based framework execution of the method, the initial Voronoi tessellation may be generated at each checkpoint, such that the optimized target deployment locations and initial Voronoi tessellation based thereon can be determined/generated based on current mission and/or external data.

The method 200 can include an eight step 216, determining, by the at least one processor, an optimized target deployment location within each Voronoi coverage region for deployment of one or more unmanned vehicles. In some embodiments, determining an optimized target deployment location within each Voronoi coverage region can include iteratively providing the current demand density as a function of location (e.g., f(s)) for each location s within a given Voronoi coverage region and the current (e.g., initial or updated) target deployment location within each Voronoi coverage region to a cost function to determine the optimized target deployment location located within each Voronoi coverage region. As described above, after each iteration of the cost function, the target deployment locations can be updated (e.g., in memory) based on the gradient output of the cost function, and each Voronoi coverage region can be iteratively updated based on the updated target deployment locations. In some embodiments, the target deployment locations and Voronoi coverage regions can be iteratively updated until it is determined that convergence has been achieved, as described above.

The method can include a ninth step 218, assigning, by the processor(s), each unmanned vehicle of the plurality to optimized target deployment location of one or more Voronoi coverage regions. For example, the processor(s) can execute the Hungarian-A*search, as described above, to assign each unmanned vehicle based on a least total cost (e.g., shortest feasible path distance) of assigning each unmanned vehicle to a given Voronoi coverage region. As further described above, assigning each unmanned vehicle can include determining if a given location along a planned path trajectory (e.g., as determined by the A*search) includes location-based restrictions (e.g., contained in the feasibility layer).

The method can include a tenth step 220, determining, by the processor(s), an executable trajectory for each unmanned vehicle to move along to its assigned optimized target deployment location. As described above, determining an executable trajectory for each unmanned vehicle can be based on one or more constraints or restrictive conditions, such as maximum battery power remaining, maximum distance capability, etc.

The method can include an eleventh step 222, outputting, by the at least one processor, one or more control signals for each unmanned vehicle of the plurality of unmanned vehicles based on the determined executable trajectory. In other words, as described above, after each executable trajectory for each unmanned vehicle has been determined, the processor(s) 102a can generate and output control signals to one or more of the unmanned vehicles to cause each of the one or more unmanned vehicles to navigate (e.g., move) toward the updated target deployment location. As described above, in some embodiments, an executable trajectory directing one or more unmanned vehicles to not move (e.g., to remain at their current target deployment location) may be determined.

In some embodiments, step 222 can include outputting, by the at least one processor, one or more control signals for one or more unmanned vehicles of the plurality of unmanned vehicles and the one or more unmanned vehicles can receive the one or more control signals and communicatively relay one or more of the control signals to one or more additional unmanned vehicles. In some embodiments, the step 222 can include outputting the executable trajectory for each unmanned vehicle to one or more unmanned vehicles and the processor(s) of each unmanned vehicle can generate and/or execute control signals based on the received executable trajectory.

In some embodiments, the method 200 can include an optional step of evaluating, by the processor(s), a failure risk for one or more unmanned vehicles of the plurality at a checkpoint interval t to determine a failure risk of each of the one or more unmanned vehicles within the next interval (e.g., before the next checkpoint interval t). The method 200 can include an additional optional step of, if it is determined that one or more unmanned vehicles have failed or will fail (e.g., if the probability of failure within the next checkpoint interval is above a predetermined threshold), assigning one or more backup unmanned vehicles to replace each failed unmanned vehicle in the plurality 101, such that each backup unmanned vehicle can be included in the subsequent optimization, assignment, and trajectory determination steps/processes. As described above, each of the steps of the method 200 may be repeated at each checkpoint interval across a mission interval until a stopping criteria is met, for example, when the mission interval ends.

In some embodiments, the method 200 can include an optional step of outputting and/or displaying on one or more visual representations (e.g., a graphical user interface) including the current demand density map, the intermediate or optimized target deployment locations, and/or the immediate or optimal Voronoi tessellation to and/or on one or more additional computing devices 102, such as a mission command computing device, operator computing device, etc., such that the current demand density map, the updated target deployment locations, and/or the updated Voronoi tessellation may be viewed by an operator for guidance and/or dispatch.

It should be understood that the above method 200 is merely exemplary, and that the method can include and/or exclude any of the described steps or processes, and that said steps or processes can be carried out by the method in any suitable order.

The following “Examples” section discusses exemplary implementations, methods, and test data related to the same.

### EXAMPLES

### Example 1—UAV Wildfire Monitoring Scenario Working Example

Example 1 illustrates a working example of addressing a static demand.

### 1. Data Reception and Formatting

In an exemplary wildfire monitoring use-case, the system can receive external data such as satellite imagery data (e.g., thermal infrared radiation, multispectral smoke or heat products, georeferenced raster tiles, etc.); fire perimeter or intensity data (e.g., rasters), for example, from fire modeling services; point data, such as incident report or hot spot points with timestamps (e.g., 911 calls, dispatch logs, crowd reports, etc.); weather and/or terrain data (e.g., wind, humidity, slope, etc.); and/or restrictive data, such as no fly zones and physical obstacles (e.g., restricted airspace polygons, terrain masks, urban exclusion zones, etc.).

The system can receive mission data including current unmanned aerial vehicle (UAV) state data (e.g., current position, altitude, battery level, payload, communications limits, etc.), UAV capability data (e.g., maximum speed, max range, endurance, sensor footprint, minimum separation, etc.), and/or mission command data (e.g., priority objectives, protected assets, service requirements, etc.).

The system can format the disparate data types into a common spatial representation. For example, the system can define an operating region P as a polygon in a map coordinate system (e.g., latitude/longitude, UTM, etc.). The system can then generate a uniform grid over the operating region P (for example N by N cells) and can determine each cell center as a location s=(x, y). The system can then convert all the received data into aligned grids and/or masks on the same coordinate system. For example, raster data can be resampled to the grid, vector data can be rasterized into masks on the grid, and/or point data can be converted to a grid using bin counts or kernel smoothing.

2. Transformation of Image Data to Demand Density Function f(s)

In this example, the exemplary received external data is a georeferenced raster I(s)=I(x, y) whose pixels map to coordinates in the operating region P, for example, a thermal infrared brightness temperature raster. The system can determine I(s) (e.g., a numeric pixel intensity value) via image processing algorithms/software modules, such that each numeric value of pixel intensity can be converted to a nonnegative demand value. For example, the system can define a fire mask/filter based on a predetermined pixel intensity threshold:

$$M ( s ) = {1}_{I ( s ) \geq τ}$$

to mark cells that are above or below the threshold. The system can convert pixel intensity to a nonnegative demand value, for example:

$${f}_{0} ( s ) = M ( s ) \cdot ( I ( s ) - τ )$$

and, optionally, can apply smoothing or neighborhood aggregation to reduce noise and fill small gaps. The system can normalize the nonnegative demand value to obtain a density field, that is, to scale f₀ to a bounded nonnegative field, for example:

$$f ( s ) = \frac{{f}_{0} ( s )}{{\sum }_{u ∈ Q} {f}_{0} ( s ) + ϵ}$$

such that higher values indicate higher service demand and the total mass can be controlled. The system can apply feasibility constraints, for example, to enforce exclusion zones and domain limits by setting:

$$f ( s ) = 0 for s ∉ Q or s ∈ N o F l y$$

Therefore, the output of the system at this stage can be a base demand density map including a nonnegative base demand value for each location s within the operating region P.

### 3. Introduction of Additional Variables to Update the Base Demand Density Map

After the generation of the base demand density map, the system can update the base demand value of one or more locations s based on, for example, mission data including current UAV locations, a planning horizon T, and per-UAV limits, such as available range or endurance Rᵢ. The system can calculate a reachable radius for each _{U}AV, rᵢ=min (vᵢT,Rᵢ), and can determine a reachability weight for each location s based on whether any UAV can reach it:

$${w}_{reach} ( s ) = \{ \begin{matrix}1 , & ∃ i such that \vert s - {μ}_{i} \vert \leq {r}_{i} \\ & 0 , otherwise\end{matrix}$$

Optionally, instead of 0 or 1, a gradual decrease with distance can be used such that locations further away are determined as less important. The system can update the demand density map using the determined reachability weight, f(s)=f(s)·W_{reach}(s), to produce an updated demand density map that is automatically reduced in areas outside of the fleet's reachable area for the current update interval.

In another example of updating the current demand density map based on mission data, the system can receive mission command data such as a polygon region A_{focus} or a target point set s*, and a priority factor β. Demand inside the focus region can be boosted:

$${w}_{task} ( s ) = \{ \begin{matrix}1 + β , & s ∈ {A}_{focus} \\ 1 , & otherwise\end{matrix}$$

and the demand value at each location s within the focus region can increase, f(s)=f(s)·Wₜₐₛₖ(s).

### 4. Exemplary Variables Optimized by the Cost Function

The cost function can be written as:

$$J ( μ ) = {\sum }_{i = 1}^{K} {\int }_{s ∈ {V}_{i}} f ( s ) {‖ s - {μ}_{i} ‖}^{2} d s$$

The decision variable μ=(μ_1, μ_2, . . . , μ_K), where μ_i (i=1, 2, . . . , K) stands for the target deployment location of UAV i, and is optimized by iterative execution of the cost function.

Vᵢ is the coverage region (polygon) assigned to UAV i, and there are K regions corresponding to K UAVs. The K UAVs start from an initial placement (for example near a fleet base), which induces an initial partition of the operating map into K Voronoi polygons (this inducing is introduced in part 5). The cost function is then used to iteratively update the UAV locations μᵢ, and after each update the partition Vᵢ is recomputed, so the UAV placements and the coverage polygons co-evolve gradually.

For a specific region Vᵢ, its corresponding UAV is at location ult. The objective can assign a cost to serving demand at each location s∈Vᵢ that is proportional to the product of the demand density f(s) and the squared distance ∥s−μᵢ∥². Therefore, μᵢ is penalized when it is far from locations with high demand density within its assigned region, for example when it is hovering over locations with little or no fire while high intensity fire locations exist elsewhere in its region. The total fleet objective can sum this demand weighted distance cost over all K regions, so the update accounts for the overall fleet level deployment rather than optimizing a single UAV in isolation.

5. Transforming the Cost Function Output into Voronoi Tesselation

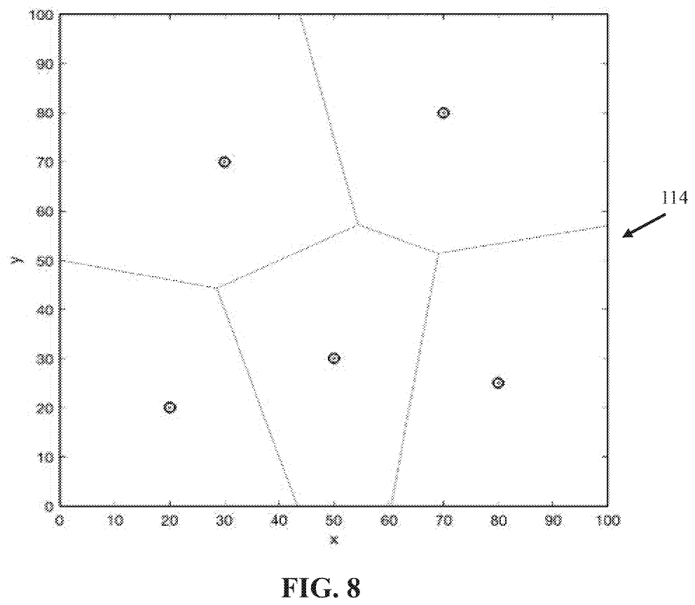

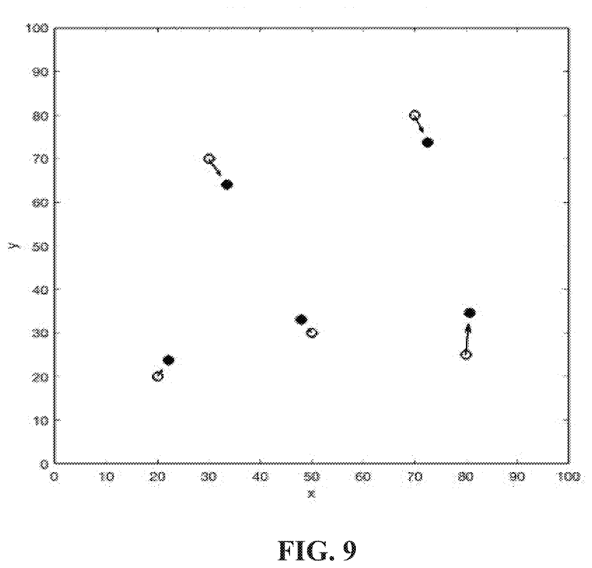

Based on the gradient of the cost function, each UAV location μᵢ is updated in the direction that reduces the demand weighted distance cost. Under this objective, the update drives μᵢ toward the demand weighted center of mass of its current Voronoi region Vᵢ, with a step magnitude proportional to the gradient magnitude. After the UAV locations are updated, a new Voronoi partition is induced by the updated set of UAV locations. FIG. 8 shows the UAV locations and Voronoi partition before the update. FIG. 9 shows the target deployment UAV locations after the update. FIG. 10 shows the Voronoi tessellation induced by the updated locations. The tessellation construction is geometric. For each pair of nearby UAVs, the boundary between their regions is the perpendicular bisector of the segment connecting the two UAV locations. This tessellation ensures each location of the Voronoi polygon is closest to its assigned UAV.

### 6. Output of the Updated UAV Deployment Location and Voronoi Tessellation.

The output (e.g., optimized target deployment locations and Voronoi tessellation) can be transmitted as command signals to the UAVs, including the updated target locations μᵢ together with the corresponding coverage region Vᵢ assigned to each UAV, where it can perform assigned tasks. The same output can also be rendered in a graphical user interface, for example by displaying the demand heatmap with the updated UAV locations and the induced Voronoi coverage partition for operator guidance and dispatch.

### Example 2—Distributed Control of Drone Swarms Under Uncertainty in Restricted Terrains

### Introduction

Unmanned Aerial Vehicles (UAVs) or drones show a high level of flexibility, ease of control, and maneuverability. Swarms of UAVs or drones have emerged as a compelling platform for coverage control applications such as disaster response, environmental monitoring, and low-altitude logistics. Coverage control involves continuous deployment and reconfiguration of UAV swarms to serve spatially distributed demand across a mission region. For example, in wildfire monitoring, UAV swarms must adapt their spatial distribution to track the advancing fire front and concentrate sensing resources on newly emerging hotspots. Despite these promising applications, real-world deployment remains challenging due to evolving conditions, practical limitations, and robustness requirements. These challenges highlight the need for coverage control strategies that can address spatiotemporally varying demand while adequately accounting for complex working environments and operational constraints.

Our previous work developed a UAV deployment framework, namely Spatiotemporal Coverage Optimization for Unmanned Tasking (SCOUT), tailored for coverage control problems involving heterogeneous demand distributions. By iterative optimization of UAV positions and coverage regions, SCOUT established a strong foundation for adaptive control of demand with large spatial variability. However, real-world coverage control problems involve greater complexity. UAVs need to be deployed under time-varying demand distributions, operational constraints, and spatial restrictions that limit feasible flight trajectories. Moreover, UAV failures can lead to degraded coverage performance. Very little has been done to investigate these uncertainty factors and practical constraints in the framework of coverage control for swarm operations.

Therefore, this paper extends SCOUT and makes the following contributions: 1.) Spatial restrictions: UAV deployment often encounters infeasible regions, such as mountainous terrain and restricted airspaces (e.g., no-drone zones). These spatial constraints alter normal flight trajectories and distort demand coverage. To address this challenge, we re-design the SCOUT updating policy and develop a Hungarian-A* path planning strategy to optimize UAV movements and ensure feasible navigation under area restrictions; 2.) Distributed control under varying demand dynamics and operational constraints: in practice, service demand is often spatially heterogenous and temporally varying. While such demand must be satisfied in an equitable way under UAV operational constraints, this paper therefore extends SCOUT by incorporating flight speed and battery capacity into dynamic coverage execution; and 3.) Reliability analysis of SCOUT: the reliability of SCOUT is an important consideration in practical coverage control problems. In real-world operations, UAVs may fail due to prolonged missions and harsh environments. This study further models UAV failures and investigates the dispatch of backup drones to restore coverage quality.

### Research Background

Centroidal Voronoi tessellation (CVT) with Lloyd-type deployment is one of the classical methods for coverage control in multi-agent systems. In this paradigm, spatial density serves as an importance field, allocating more sensing or service resources to higher-demand regions. For instance, Liu et al. adapted this framework to model infectious disease spread for epidemic decision support. Similarly, Zhu et al. applied it to optimize resource allocation for the coverage control of city crimes. Alongside these applications, similar concepts have been adapted for UAV and multi-robot missions under non-uniform and evolving fields. For example, Guruprasad et al. developed automated multi-agent search using centroidal Voronoi configurations and analyzed deploy-and-search strategies under uncertainty. Sharifi et al. explored cooperative multi-vehicle search and coverage in uncertain environments. These studies demonstrate that Voronoi/CVT-based coverage with non-uniform demand is a well-established foundation in both static and dynamic settings. However, very little has been done to investigate distributed coverage control under evolving dynamics of spatiotemporal demand and UAV execution requirements in restricted environments.

For real-world UAV swarm deployment, optimizing cover-age quality alone is insufficient; the resulting configurations must be safely executable under physical flight limitations and resilient to in-flight failures. Prior studies have explored multi-agent coverage under dynamic conditions and cluttered environments. For instance, Lee et al. and Abdulghafoor et al. investigated distributed coverage control with time-varying density functions and obstacle avoidance. While these works successfully adapt swarm configurations to shifting spatiotemporal demand, they focus primarily on the geometric evolution of the swarm rather than on both physical execution and path updates over time. At the same time, reliability-oriented studies demonstrate that individual UAV dropouts severely disrupt mission continuity. Dui et al. and Li et al. showed that failure-aware path planning and structural optimization are important for sustaining overall swarm effectiveness. Together, these studies highlight the necessity of incorporating both operational constraints and hardware reliability into UAV mission design. However, a key gap remains in the domain of coverage control. Very few studies jointly address evolving demand, executable multi-UAV path planning under operational constraints, and failure recovery in restricted environments.

### Methodology

### Distributed Coverage Control of Spatiotemporal Demand Dynamics Under Operational Constraints

Dynamic coverage control addresses how a UAV swarm should be redeployed in response to evolving demand distribution across a spatial region. It is important in real-world missions because changes in demand require UAVs to adapt their positions to maintain effective coverage. This section extends the SCOUT framework to address dynamic coverage control involving multi-UAV deployment under heterogeneous, time-varying demand and operational constraints.

### 1.) Spatiotemporal Formulation

Let the mission horizon [0, T] be discretized into intervals of duration T₀>0, and define N≙[T/T₀]. To denote the discrete checkpoints, t=0, 1, . . . , N, where the corresponding physical time is tT₀. For a spatial domain P, the demand density at checkpoint t is:

$${f}_{t} ( s ) {=}^{△} f ( s , {tT}_{0} ) , s ∈ 𝒫 , t = 0 , 1 , … , N . \qquad ( 1 )$$

Let x[t]≙{x₁[t], . . . , x_{M}[t]} denote the locations of the MUAVs at checkpoint t, where xᵢ[t]∈R². These locations can induce a Voronoi tessellation

$${\{ {V}_{i} ( x [ t ] ) \}}_{i = 1}^{M}$$

over P. The coverage cost at checkpoint t can be defined as:

$${C}_{t} ( x [ t ] ) = {\sum }_{i = 1}^{M} {\int }_{{V}_{i} ( x [ t ] )} {‖ s - {x}_{i} [ t ] ‖}^{2} {f}_{t} ( s ) ds . \qquad ( 2 )$$

Assuming the UAV configuration remains fixed over each interval [tT₀, (t+1)T₀], the dynamic coverage-control problem can be formulated as:

$${min}_{{\{ x [ t ] \}}_{t = 0}^{N}} {\sum }_{t = 0}^{N - 1} {C}_{t} ( x [ t ] ) . \qquad ( 3 )$$

At each checkpoint t, SCOUT updates the deployment by minimizing Cₜ(x[t]T₀), the gradient of Cₜ is:

$$\frac{\partial {C}_{t}}{\partial {x}_{i} [ t ]} = 2 {M}_{i} ( x [ t ] ) ( {x}_{i} [ t ] - {ζ}_{i} ( x [ t ] ) ) , \qquad ( 4 )$$

$$where :$$

$${M}_{i} ( x [ t ] ) {=}^{△} {\int }_{{V}_{i} ( x [ t ] )} {f}_{t} ( s ) ds \qquad ( 5 )$$

is the demand mass of region Vᵢ(x[t]), and

$${ζ}_{i} ( x [ t ] ) {=}^{△} \frac{{\int }_{{V}_{i} ( s [ t ] )} {sf}_{t} ( s ) ds}{{\int }_{{V}_{i} ( x [ t ] )} {f}_{t} ( s ) ds} \qquad ( 6 )$$

is its demand-weighted centroid. Thus, the stationary condition

$${x}_{i} [ t ] ← {x}_{i} [ t ] - α \frac{\partial {C}_{t}}{\partial {x}_{i} [ t ]} , \qquad ( 8 )$$

implies:

$$\vert {x}_{i} [ t ] = {ζ}_{i} ( x [ t ] ) , \qquad ( 7 )$$

showing that each UAV is driven toward the center of mass of its Voronoi region. Accordingly, the deployment can be iteratively updated by:

$${x}_{i} [ t ] ← {x}_{i} [ t ] - α \frac{\partial {C}_{t}}{\partial {x}_{i} [ t ]} , \qquad ( 8 )$$

where α>0 is the step size. Repeating this procedure at successive checkpoints can allow the swarm to track evolving demand and update target locations over time.

### 2.) Coverage Control Under Area Restrictions:

Let

$${\{ {H}_{h} \}}_{h = 1}^{H}$$

denote a set of restricted regions within the spatial domain P. The feasible region for deployment can be defined as:

$$ℱ {=}^{△} 𝒫 \backslash {{⋃}_{h = 1}}^{H} {ℋ}_{h} . \qquad ( 9 )$$

To account for inaccessible zones during cost evaluation, the demand over restricted areas can be set to zero, i.e., f(s, t)=0 for all s∈f. Consequently, Voronoi partitions can be effectively clipped to the feasible space.

To robustly handle irregular and nonconvex restricted geometries, each restricted region is represented by a conservative convex envelope:

$${\hat{ℋ}}_{h} {=}^{Δ} conv ( {ℋ}_{h} ) . \qquad ( 10 )$$

Because [symbol] ₕ⊆ [symbol] ₕ, this treatment can preserve exclusion of all originally restricted locations while regularizing boundary geometry for stable iterative optimization.

Building upon the gradient descent policy,

$${let}_{Xi}^{∼} {=}^{Δ} {x}_{i} - α ∇ xi {C}_{n} ( x [ n ] )$$

represent the unconstrained candidate location for UAV i. Feasibility is enforced in each SCOUT update through the projection operator Π_{F}(·):

$${x}_{i} ← {\prod }_{ℱ} ( {\tilde{x}}_{i} ) . \qquad ( 11 )$$

$${If}_{Xi}^{∼}$$

lies inside a restricted envelope (i.e., \tilde{x}ᵢ∈ [symbol] ₕ), Π_{F}(·) can map it to the nearest boundary point of [symbol] ₕ and can apply a small outward offset to maintain strict feasibility. Since each [symbol] ₕ is convex, the nearest-point projection is unique, yielding consistent and numerically stable updates throughout the deployment process.

### 3.) Checkpoint Execution Under Speed and Battery Constraints

In addition to spatial coverage, UAV motion must satisfy operational constraints on speed and onboard energy. Let vₘₐₓ>0 denote the maximum horizontal speed. To represent battery limitations, a distance-equivalent energy budget can be adopted, where the available battery can be converted into a maximum executable flight range Dₘₐₓ>0. Let d_{F}(s₁, s₂) denote the length of the shortest feasible path within F connecting locations s₁ and s₂.

Let xᵢ[t]∈R² be the physical location of UAV i at checkpoint t. Over a checkpoint interval of duration T₀, the speed constant is:

$${d}_{ℱ} ( {x}_{i} [ t ] , {x}_{i} [ t + 1 ] ) \leq {v}_{max} {T}_{0} , ∀ i , t = 0 , … , N - 1. \qquad ( 12 )$$

The cumulative executed flight distance of UAV I up to checkpoint t can be tracked as:

$${L}_{i} [ t ] {=}^{Δ} {\sum }_{τ = 0}^{t - 1} {d}_{ℱ} ( {x}_{i} [ τ ] , {x}_{i} [ τ + 1 ] ) , {L}_{i} [ 0 ] = 0. \qquad ( 13 )$$

Under the distance-equivalent model, the remaining range can be Dₘₐₓ−Lᵢ[t], and the battery constraint can be:

$${L}_{i} [ t ] \leq {D}_{max} , ∀ i , t = 0 , … , N . \qquad ( 14 )$$

At checkpoint t, SCOUT, under the corresponding demand field, can produce a set of M target locations. Since the coverage objective is invariant to permutations of the M UAVs, these targets can be treated as an unordered set, denoted by:

$$\hat{𝒳} [ t + 1 ] = \{ {\hat{x}}_{1} [ t + 1 ] , … , {\hat{x}}_{M} [ t + 1 ] \}$$

To reduce total travel distance, we assign current UAV locations to these targets by solving a linear assignment problem. Specifically, we seek a bijection π*: {1, . . . , M}→{1, . . . , M} that minimizes the total feasible path length:

$${π}^{*} = arg {min}_{π} {\sum }_{i = 1}^{M} {d}_{ℱ} ( {x}_{i} [ t ] , {\hat{x}}_{π ( i )} [ t + 1 ] ) . \qquad ( 15 )$$

To account for path feasibility in restricted environments, the pairwise transition costs d_{F}(·,·) using a grid-based obstacle-aware A* search over the feasible space F. The resulting environment-aware path costs are then incorporated into the Hungarian algorithm to solve the swarm-level assignment problem in equation (15).

Once assigned, let γᵢ[t]⊂F be a feasible path from xᵢ[t] to \hat{x}_{π*(i)}[t+1] with length:

$${ℓ}_{i} [ t ] {=}^{Δ} {d}_{ℱ} ( {x}_{i} [ t ] , {\hat{x}}_{{π}^{*} ( i )} [ t + 1 ] ) . \qquad ( 16 )$$

The executable travel distance during checkpoint t can then be limited by the planned path length, the speed bound, and the remaining executable range:

$${Δℓ}_{i} [ t ] {=}^{Δ} min ( {ℓ}_{i} [ t ] , {v}_{max} {T}_{0} , {R}_{max} - {L}_{i} [ t ] ) . \qquad ( 17 )$$

The next checkpoint location xᵢ[t+1] is obtained by moving from xᵢ[t] along γᵢ[t] for arc length ΔIᵢ[t], and the distance bookkeeping can be updated by:

$${L}_{i} [ t + 1 ] = {L}_{i} [ t ] + {Δℓ}_{i} [ t ] . \qquad ( 18 )$$

If ΔIᵢ[t]=0, the UAV remains at its current location, that is, xᵢ[t+1]=xᵢ[t]. This hovering treatment is reasonable because the UAV can still provide sensing or communication coverage over its local neighborhood even when further motion is temporarily prevented by speed or energy limits. In this way, checkpoint-level execution can enforce speed and battery constraints while preserving the SCOUT deployment targets through an energy-efficient assignment step.

### B. Reliability Modeling and Backup Dispatch for UAV Swarms

Long-duration missions and harsh operating conditions can induce UAV failures, reducing the active fleet size and degrading overall coverage quality. Consequently, reliability analysis allows decision makers to answer operational planning questions such as “How do UAV failures impact coverage quality?” and “How many backup UAVs are required to restore coverage performance?” In this experiment, we model the lifetime of each UAV as a Weibull random variable and denote the operational age of UAV i by aᵢ. The Weibull distribution is adopted because it provides a flexible and widely used model for time-to-failure data in reliability analysis. Specifically, the reliability function can be given by:

$$R ( {a}_{i} ) = exp ( - {( \frac{{a}_{i}}{λ} )}^{k} ) , \qquad ( 19 )$$

where λ>0 and k>0 are the scale and shape parameters, respectively.

Failures can be evaluated at checkpoint boundaries separated by interval duration T₀. If UAV i is operational at checkpoint t with age aᵢ[t], then its conditional probability of failure over the next interval is:

$$\begin{matrix}{p}_{f , i} [ t ] {=}^{Δ} 1 - \frac{R ( {a}_{i} [ t ] + {T}_{0} )}{R ( {a}_{i} [ t ] )} \\ = 1 - exp ( - [ {( \frac{{a}_{i} [ t ] + {T}_{0}}{λ} )}^{k} - {( \frac{{a}_{i} [ t ]}{λ} )}^{k} ] )\end{matrix} . \qquad ( 20 )$$

This checkpoint-based formulation enables failure risk to be updated consistently with the dynamic deployment process.

To maintain coverage after failures, a checkpoint-level backup dispatch mechanism from a depot located a x_{depot}∈F. Let Wₜ denote the set of UAVs that fail during interval t, and let Sₜ−{1, . . . , W}\Wₜ denote the surviving UAVs. Before optimizing deployment at checkpoint t+1, each failed UAV can be replaced by a backup UAV dispatched from the depot. The initial configuration can then be defined as:

$${\tilde{x}}_{i} [ t + 1 ] = \{ \begin{matrix}{x}_{i} [ t + 1 ] , & if i ∈ {𝒮}_{t} , \\ {x}_{depot} , & if i ∈ {𝒲}_{t} .\end{matrix} \qquad ( 21 )$$

For each backup UAV i∈Mt, the operational age and cumulative travel distance are reset as aᵢ[t+1]=0 and Dᵢ[t+1]=0. The assembled state {\tilde{x}₁[t+1], . . . , \tilde{x}_{M}[t+1]} can then be used to initialize SCOUT at checkpoint t+1.

### EXPERIMENTAL DESIGN AND RESULTS

The proposed methodology is evaluated and validated by three cases. The first examines the performance of SCOUT over a 3D mountainous terrain with restricted areas, where UAV altitude configurations are adjusted to alter feasible regions. The second studies spatiotemporal deployment of UA Vs under time-varying demand distributions while incorporating operational constraints, including flight speed and battery capacity. The third introduces UAV failures and the deployment of backup drones to evaluate system robustness and the effectiveness of depot-based backup dispatch.

### Example 2A: Coverage Control Tasking Over Restricted 3D Terrain (e.g., Static Demand with Restricted-Area Constraints)

To evaluate the algorithm's performance in environments with complex spatial constraints, a 3D mountainous topography was simulated using a fractal surface model. The terrain is synthesized via the midpoint displacement algorithm, parameterized by a Hurst exponent to ensure statistically realistic roughness and continuous elevation variations.

In this scenario, UAVs can be constrained by a maximum operational flight altitude, denoted as Zₘₐₓ, which can be defined relative to the normalized terrain height. Given the terrain elevation profile z(s), the inaccessible region is formally defined as H(Zₘₐₓ)={s∈P: z(s)>Zₘₐₓ}. These constitute the restricted regions Hₕ in the 2D mission space.

To analyze the algorithm's boundary-handling capabilities, the normalized altitude limit can be varied as Zₘₐₓ∈{0.15, 0.014, 0.013} km, where a lower threshold yields progressively larger and more complex restricted areas.

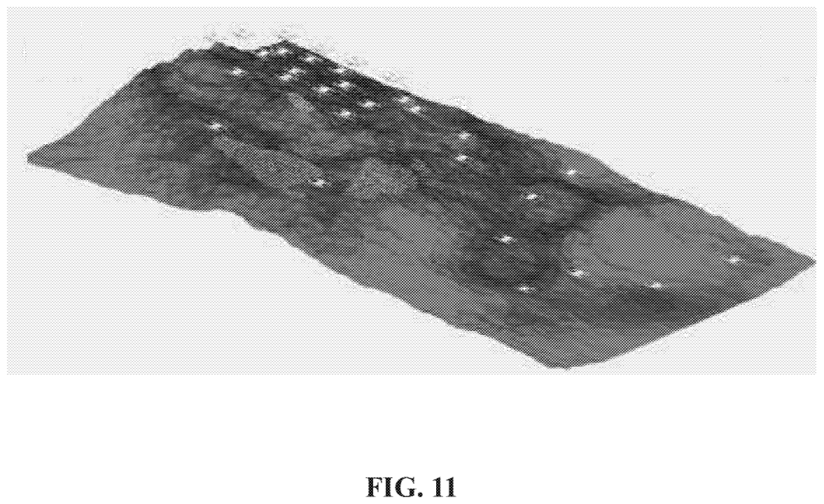

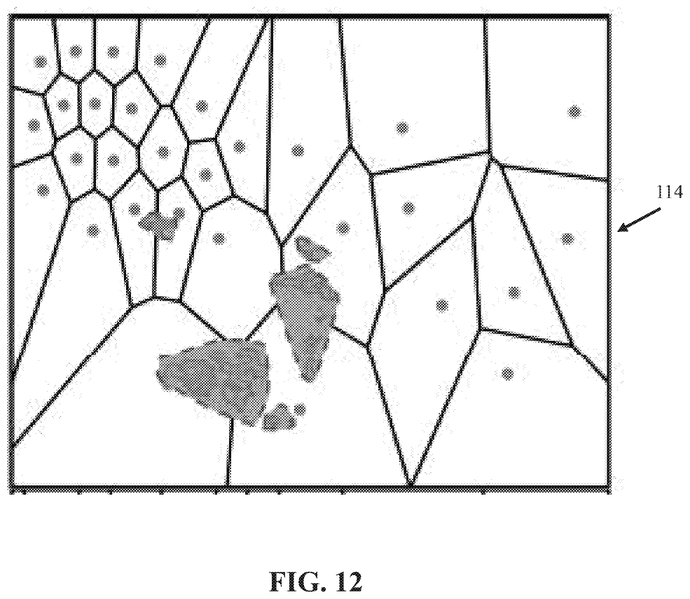

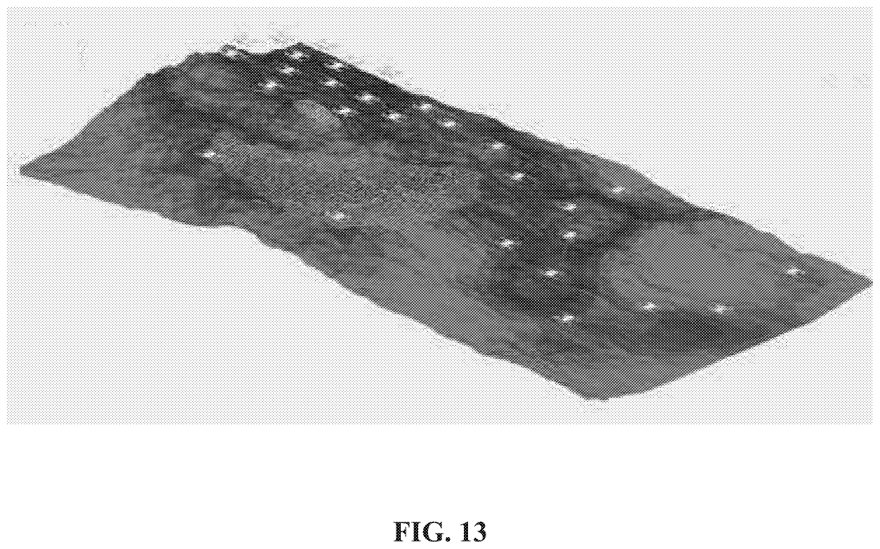

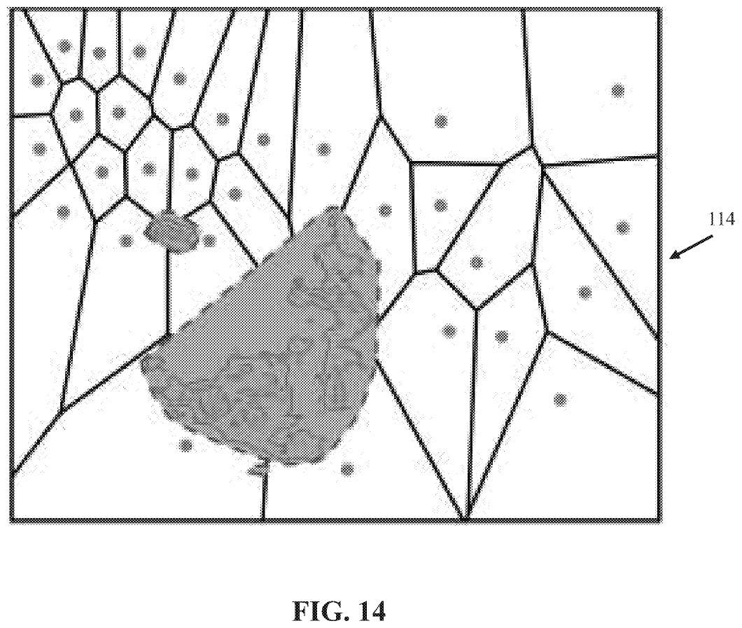

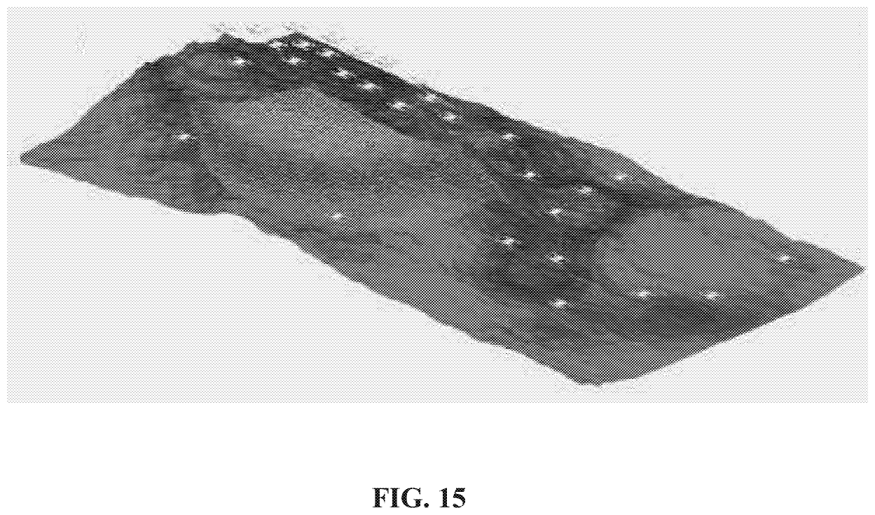

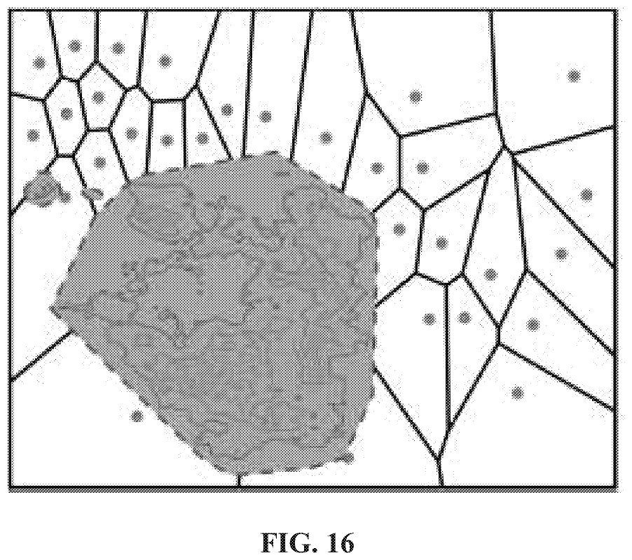

FIGS. 11-16 illustrate the final deployment configurations under three different altitude constraints in a static demand setting. As Zₘₐₓ decreases from 0.15 to 0.13 (top to bottom), the inaccessible topographic region expands significantly. FIGS. 11 and 12 illustrate a demand density map and corresponding Voronoi tessellation, respectively, for a maximum altitude of 0.15, FIGS. 13 and 14 illustrate a demand density map and corresponding Voronoi tessellation, respectively, for a maximum altitude of 0.14, and FIGS. 15 and 16 illustrate a demand density map and corresponding Voronoi tessellation, respectively, for a maximum altitude of 0.13.

As formulated in Section III-A.2, these irregular restricted regions are approximated by their convex hulls (depicted as gray dashed polygons in subfigures (b), (d), and (f)). The 2D Voronoi tessellations demonstrate that the modified SCOUT algorithm successfully reconfigures the swarm around these growing obstacles. The differing restricted-region geometries produce distinct tessellation patterns, highlighting the need for terrain-adaptive UAV deployment. Overall, these results show that the revised SCOUT updating policy maintains effective UAV deployment while adapting to increasingly restrictive terrain.

### Example 2B: Continuous Deployment Under Evolving Demand and Operational Constraints (e.g., Time-Varying Demand with Restricted-Area and Operational Constraints)

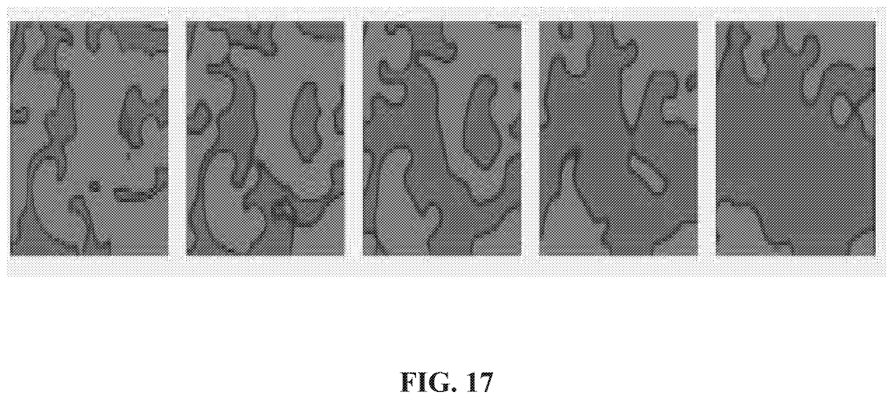

To further evaluate the adaptability of the proposed method in dynamic environments, we extend the previous experiment from restricted 3D terrain to a setting that also incorporates evolving demand over time, while fixing the altitude limit at Zₘₐₓ=0.14 km. Under this setting, the spatiotemporal demand field is modeled over a 200-second planning horizon on a 1 km 2 km rectangular region using a reaction-diffusion process. This process is a classical model for distributed dynamic phenomena such as wildfire spread, toxic chemical plumes, and marine oil spills. The demand density is updated every 10 seconds, for example, from satellite observations, whereas UAV deployment is updated at checkpoints. In this experiment, we use 10 checkpoints, resulting in a checkpoint interval of T₀=20 seconds. This discretization is case-specific and may be selected according to mission dynamics and operational needs. FIG. 17 shows the shifting high-demand regions at checkpoints t=1, 3, 5, 7, and 9, from left to right.

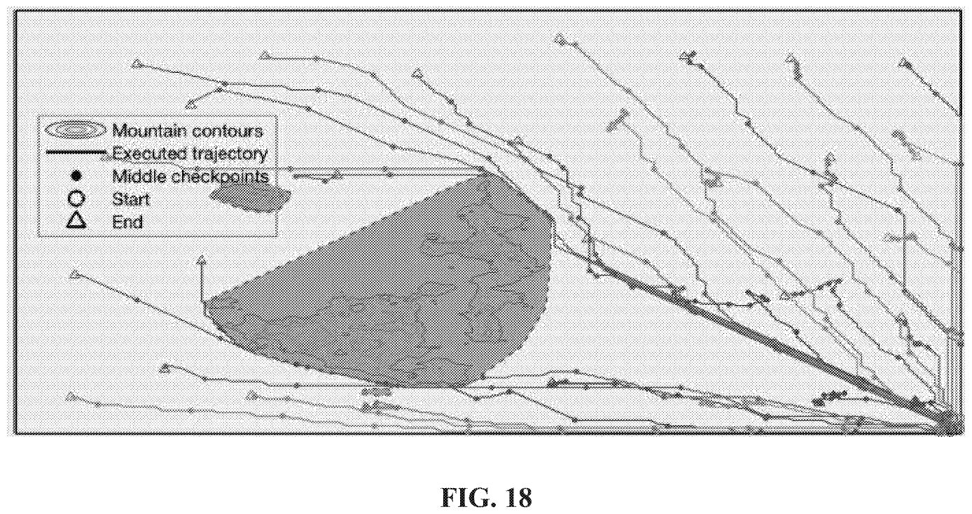

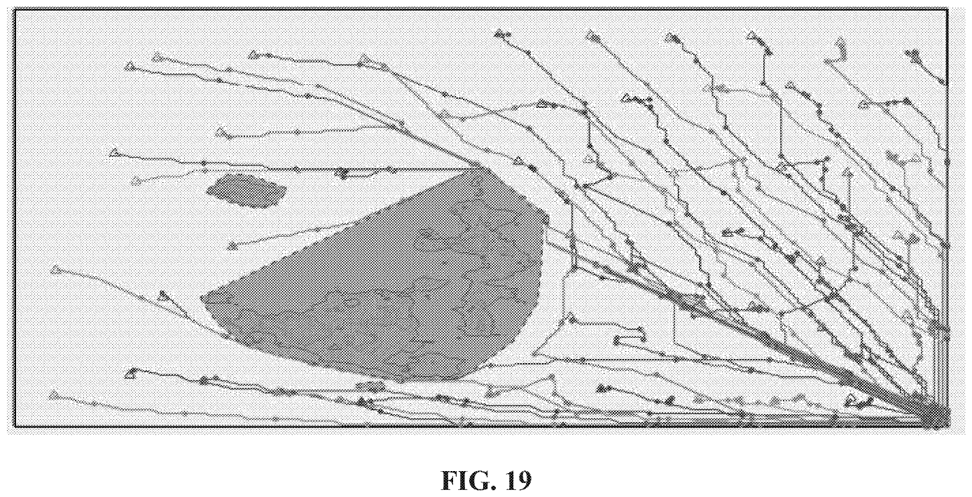

The continuous execution of the swarm can then be analyzed under operational constraints. In this example, we set the maximum speed to vₘₐₓ=0.02 km/s and the battery-related travel budget to Dₘₐₓ=2 km. FIGS. 18 and 19 display the resulting executable trajectories for swarms of varying sizes (M=30 (FIG. 18) and 50 UAVs (FIG. 19)) over the entire 10 checkpoint mission.

Starting from a localized base, the UAVs can systematically fan out to track the dynamically deforming demand peaks. The trajectories remain feasible throughout the mission and consistently avoid the restricted area (mountain contours). Trajectories generated by direct SCOUT iteration can be compared with those produced by the proposed Hungarian-A* assignment, which reduces the average trajectory lengths from 1.40 and 1.36 to 1.25 and 1.22 for M=30 and 50, respectively. Moreover, the directionally similar trajectories indicate consistent movement toward dominant high-demand locales, further demonstrating SCOUT's demand-focused deployment behavior.

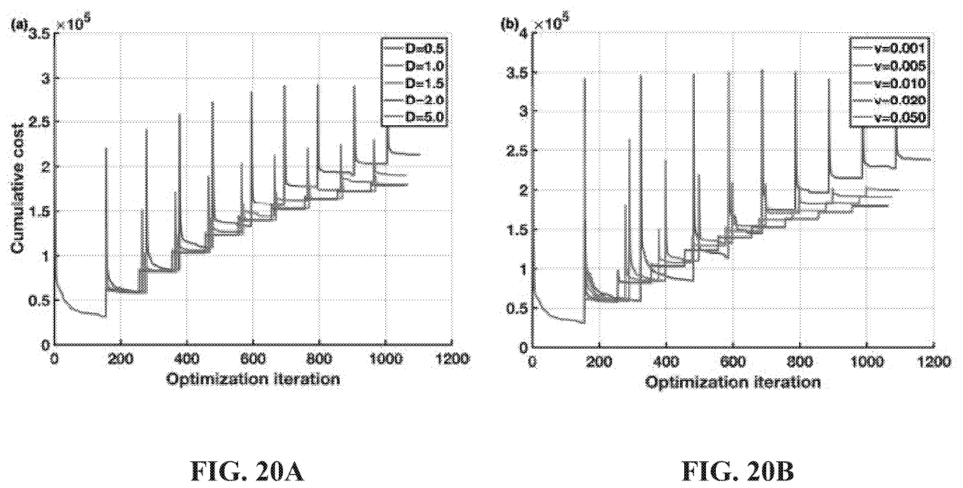

FIGS. 20A and 20B show convergence under different operational constraints for a 30-UAV swarm. FIG. 20A isolates the speed limit by fixing the battery budget at Dₘₐₓ=5.0, while FIG. 20B isolates the battery effect by fixing the speed limit at vₘₐₓ=0.05. At each checkpoint transition, the cumulative cost jumps because the demand field changes, then decreases to a near plateau, indicating convergence within that snapshot. Tighter speed or battery limits can produce larger jumps and slower decay, since UAVs cannot reach their demand-weighted centroids as quickly. As a result, stricter constraints can require more iterations and yield higher cumulative cost. Overall, this experiment validates the framework's capacity to maintain continuous, effective coverage in dynamic environments without violating practical operational constraints.

### Example 2C: Reliability Analysis Under UAV Failures (e.g., Time-Varying Demand with Restricted-Area and Operational Constraints, Further Considering Failures and Backup Dispatch)

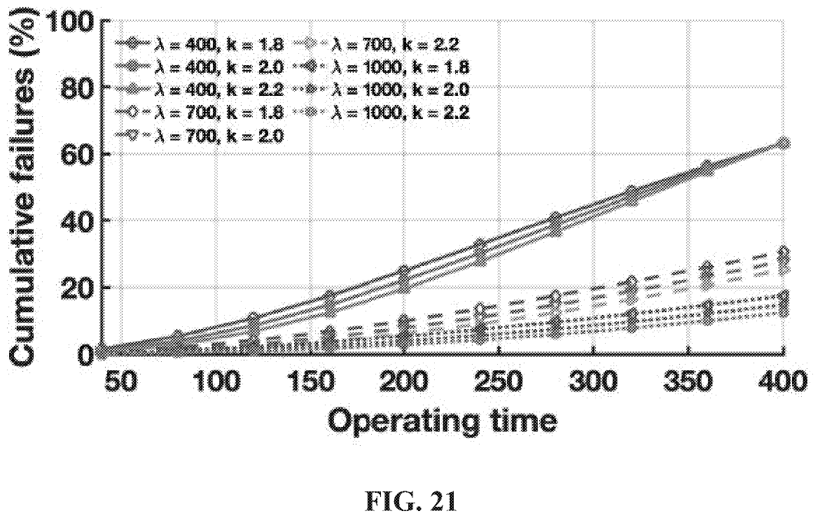

Building upon the spatiotemporal evolution framework of Experiment 2, this scenario incorporates probabilistic UAV dropouts over the planning horizon. Failures can be modeled using the operating-time-dependent reliability function in the Reliability Modeling and Backup Dispatch for UAV Swarms section above. FIG. 21 shows the cumulative drone failure percentage over operating time under different Weibull parameter settings. For a fixed shape parameter k, larger 2 leads to slower failure accumulation, indicating a longer characteristic lifespan and better reliability over time. For a fixed 2, larger k produces a steeper increase in cumulative failures, indicating faster reliability degradation as operating time grows. Such trends motivate robust coverage control under random dropouts.

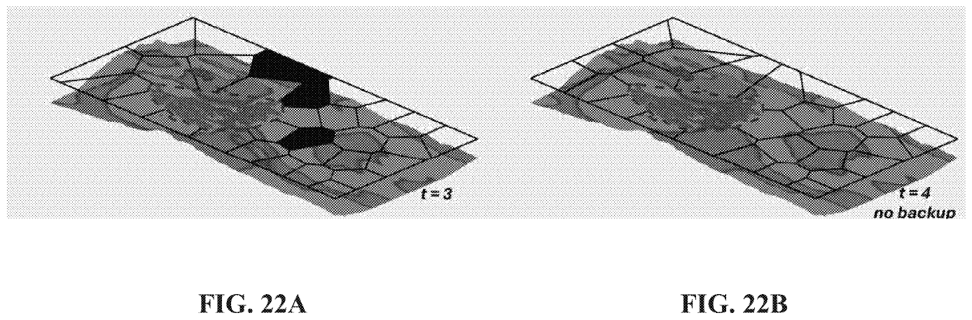

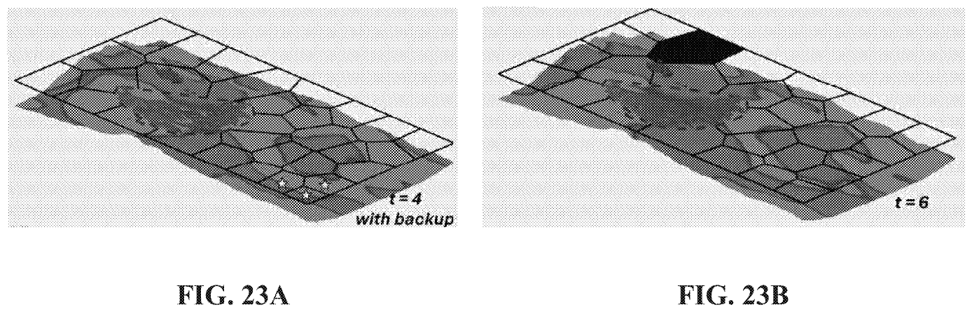

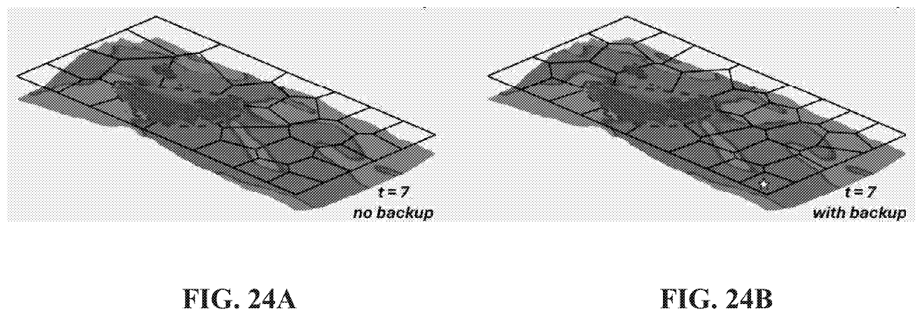

FIGS. 22A-24B compares the no-backup and backup responses after UAV failures at checkpoints 3 and 6. In each case, the black region shown in FIGS. 22A and 23B denotes the service region of the failed UAV at checkpoint t. FIGS. 22B and 24A and FIGS. 23A and 24B show the reconfigured tessellations at checkpoint t+1 without (FIGS. 22B and 24A) and with backup UAVs (FIGS. 23A and 24B), respectively, where backups are marked by white stars. In both cases, the swarm reconfigures with limited movement because checkpoint-based updates keep demand changes between consecutive checkpoints moderate, and the Hungarian assignment efficiently rematches UAVs to new target regions. Compared with the no-backup dispatch, backup restores the failed service region more effectively and better addresses high-demand areas.

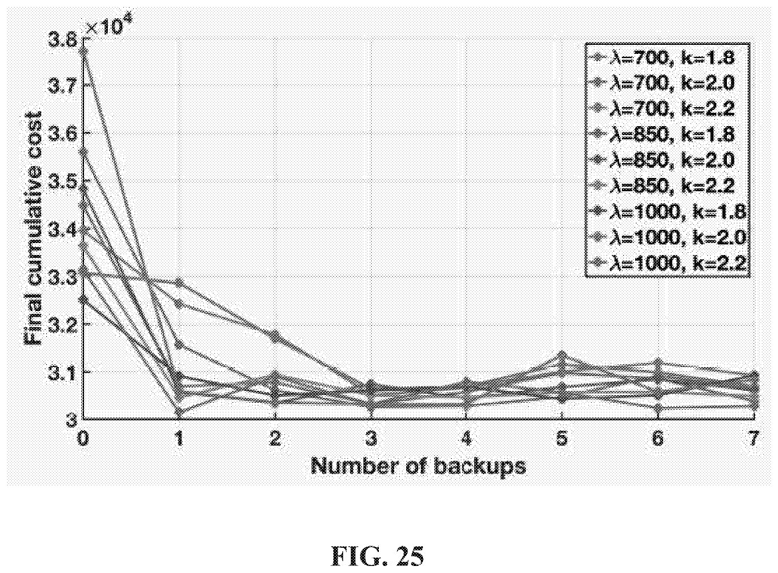

The effect of backup capacity was studied by varying the maximum number of backups available at each checkpoint, together with the Weibull failure parameters λ and k. AS shown in FIG. 25, increasing the number of backups generally reduces the final cumulative coverage cost, indicating better coverage quality under failures. However, the cost changes very little once the backup limit exceeds 4. This suggests that failures per interval rarely exceed 4 in the simulated settings, so backup capacities above 4 may add little benefit. This highlights a key design principle: reserve resources should be allocated where they deliver the greatest gain in coverage quality.

### CONCLUSIONS

A distributed control framework of drone swarms under uncertainty in restricted terrains is presented. The proposed method formulates feasible-region coverage control for restricted environments, introduces a checkpoint-based execution scheme under speed and battery constraints to track spatially- and temporally-evolving demand, and incorporates reliability-aware operation through probabilistic failure modeling and backup dispatch to improve swarm resilience. Experimental results show that the proposed framework adapts to restricted terrain, evolving demand, and UAV failures while maintaining feasible deployment, constraint compliance, and resilient coverage performance. By explicitly bridging the gap between theoretical optimization and physical flight limitations, this approach shows strong potential for demand-aware swarm deployments that are continuous and physically executable in complex field environments.

It should be understood that the disclosure of a range of values is a disclosure of every numerical value within that range, including the end points. It should also be appreciated that some components, features, and/or configurations may be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiment. Thus, the components, features, and/or configurations of the various embodiments can be combined together in any manner and such combinations are expressly contemplated and disclosed by this statement.

It will be apparent to those skilled in the art that numerous modifications and variations of the described examples and embodiments are possible considering the above teachings of the disclosure. The disclosed examples and embodiments are presented for purpose of illustration only. Other alternate embodiments may include some or all of the features disclosed herein. Therefore, it is the intent to cover all such modifications and alternate embodiments as may come within the true scope of this invention, which is to be given the full breadth thereof.

It should be understood that modifications to the embodiments disclosed herein can be made to meet a particular set of design criteria. Therefore, while certain exemplary embodiments of the compositions, materials, apparatuses, and methods of using and making the same disclosed herein have been discussed and illustrated, it is to be distinctly understood that the invention is not limited thereto but may otherwise be variously embodied and practiced within the scope of the following claims.

What is claimed is:

1. A system for optimized tasking of unmanned vehicles, comprising:
at least one computing device comprising:
at least one processor communicatively connected to a non-transitory computer-readable storage medium;
a plurality of unmanned vehicles communicatively connected to the at least one computing device and configured to transmit data to and receive data from the at least one computing device, each unmanned vehicle of the plurality comprising a control system configured to operatively control the unmanned vehicle;
the non-transitory computer-readable storage medium having code stored thereon such that the system is configured to, at each checkpoint time interval of a mission time interval:
receive, by the at least one processor, at least one of external data or mission data from one or more external data sources or one or more mission data sources in communicative connection with the at least one computing device;
generate in a map coordinate system, by the at least one processor, a demand density map of a geographic area in which the plurality of unmanned vehicles are to perform one or more tasks, the demand density map including one or more grids or masks including the external and/or mission data and aligned over a uniform cell grid of the demand density map;
calculate, by the at least one processor, a demand value for each cell of the uniform cell grid based on the external data and/or the mission data correspondingly aligned with each cell center in the one or more grids or masks;
generate, by the at least one processor, a Voronoi tessellation including a plurality of Voronoi polygons, the plurality including one Voronoi polygon for each unmanned vehicle of the plurality, and each Voronoi polygon including a target deployment location;
iteratively execute, by the at least one processor, a cost function, wherein the demand value for each cell of the uniform cell grid and each target deployment location are provided to the cost function as input, wherein, after each iteration, each target deployment location is updated based on the cost function output and the Voronoi tessellation is updated based on the updated target deployment locations, and wherein the cost function is iteratively executed until it is determined that convergence is achieved;
assign, by the at least one processor, one or more unmanned vehicles to each target deployment location;
determine, by the at least one processor, an executable trajectory for each unmanned vehicle of the plurality of unmanned vehicles;
transmit, via the communicative connection, the executable trajectory for each unmanned vehicle to the plurality of unmanned vehicles; and
wherein, the control system of each unmanned vehicle of the plurality of unmanned vehicles is further configured to cause each unmanned vehicle to move within the geographic area based on its respective executable trajectory.

2. The system of claim 1, wherein the external data comprises at least one of satellite image data, incident report data, weather data, restricted area data, or environmental modeling data.

3. The system of claim 1, wherein the mission data comprises at least one of unmanned vehicle operational data or mission command data, wherein the mission command data comprises at least one of a target focus location or a target focus area, and a priority factor.

4. The system of claim 1, wherein calculating a demand value for each cell of the uniform cell grid based on the external data and/or the mission data correspondingly aligned with each cell center in the one or more grids or masks comprises:
converting, by the at least one processor, the external and/or mission data of each mask and grid to a normalized nonnegative demand value; and
determining a total demand value for each cell of the uniform cell grid based on a combination of each normalized nonnegative demand value correspondingly aligned with the cell.

5. The system of claim 1, wherein the one or more unmanned vehicles are assigned to each target deployment location using a Hungarian algorithm.

6. The system of claim 5, wherein the Hungarian algorithm assigns the one or more unmanned vehicle to each target deployment location based on a cost matrix output by an A* search.

7. The system of claim 1, wherein the executable trajectory for one or more unmanned vehicles of the plurality of unmanned vehicles is determined based on one or more unmanned vehicle operational constraints.

8. The system of claim 1, wherein the system is further configured to:
generate, by the at least one processor, one or more control signals for each unmanned vehicle based on the determined executable trajectory for each unmanned vehicle; and
transmit, via the communicative connection, the one or more control signals for each unmanned vehicle to each unmanned vehicle to cause the unmanned vehicle to move toward its target deployment location.

9. The system of claim 1, wherein the system is further configured to:
transmit, via the communicative connection, the executable trajectory for each unmanned vehicle to one or more first unmanned vehicles of the plurality, wherein the communicative connection is a first communicative connection and wherein the one or more first unmanned vehicles of the plurality are in a second communicative connection with one or more second unmanned vehicles of the plurality; and
transmit, via the second communicative connection, each executable trajectory for each one or more second unmanned vehicles to each of the one or more second unmanned vehicles.

10. The system of claim 1, wherein the system is further configured to:
generate one or more visual representations including at least one of a current Voronoi tessellation, the current target deployment location of each unmanned vehicle, or the demand density map; and
transmit the one or more visual representations to at least one operator computing device in communicative connection with the at least one computing device.

11. A method for optimized tasking of unmanned vehicles, comprising:
performing at each checkpoint time interval of a mission time interval comprising a plurality of checkpoint time intervals, by at least one processor of at least one computing device, the steps of:
receiving, by the at least one processor, at least one of external data or mission data from one or more external data sources or one or more mission data sources in communicative connection with the at least one computing device;
generating in a map coordinate system, by the at least one processor, a demand density map of a geographic area in which the plurality of unmanned vehicles are to perform one or more tasks, the demand density map including one or more grids or masks including the external and/or mission data and aligned over a uniform cell grid of the demand density map;
calculating, by the at least one processor, a demand value for each cell of the uniform cell grid based on the external data and/or the mission data correspondingly aligned with each cell center in the one or more grids or masks;
generating, by the at least one processor, a Voronoi tessellation including a plurality of Voronoi polygons, the plurality including one Voronoi polygon for each unmanned vehicle of the plurality, and each Voronoi polygon including a target deployment location;
iteratively executing, by the at least one processor, a cost function, wherein the demand value for each cell of the uniform cell grid and each target deployment location are provided to the cost function as input, wherein, after each iteration, each target deployment location is updated based on the cost function output and the Voronoi tessellation is updated based on the updated target deployment locations, and wherein the cost function is iteratively executed until it is determined that convergence is achieved;
assigning, by the at least one processor, one or more unmanned vehicles to each target deployment location;
determining, by the at least one processor, an executable trajectory for each unmanned vehicle of the plurality of unmanned vehicles;
transmitting, via the communicative connection, the executable trajectory for each unmanned vehicle to the plurality of unmanned vehicles; and
wherein, the control system of each unmanned vehicle of the plurality of unmanned vehicles is further configured to cause each unmanned vehicle to move within the geographic area based on its respective executable trajectory.

12. The method of claim 11, wherein the external data comprises at least one of satellite image data, incident report data, weather data, restricted area data, or environmental modeling data.

13. The method of claim 11, wherein the mission data comprises at least one of unmanned vehicle operational data or mission command data, wherein the mission command data comprises at least one of a target focus location or a target focus area, and a priority factor.

14. The system of claim 1, wherein calculating a demand value for each cell of the uniform cell grid based on the external data and/or the mission data correspondingly aligned with each cell center in the one or more grids or masks comprises:
converting, by the at least one processor, the external and/or mission data of each mask and grid to a normalized nonnegative demand value; and
determining a total demand value for each cell of the uniform cell grid based on a combination of each normalized nonnegative demand value correspondingly aligned with the cell.

15. The method of claim 11, wherein the one or more unmanned vehicles are assigned to each target deployment location using a Hungarian algorithm.

16. The method of claim 15, wherein the Hungarian algorithm assigns the one or more unmanned vehicle to each target deployment location based on a cost matrix output by an A* search.

17. The method of claim 11, wherein the executable trajectory for one or more unmanned vehicles of the plurality of unmanned vehicles is determined based on one or more unmanned vehicle operational constraints.

18. The method of claim 11, further comprising:
generating, by the at least one processor, one or more control signals for each unmanned vehicle based on the determined executable trajectory for each unmanned vehicle; and
transmitting, via the communicative connection, the one or more control signals for each unmanned vehicle to each unmanned vehicle to cause the unmanned vehicle to move toward its target deployment location.

19. The method of claim 11, further comprising:
transmitting, via the communicative connection, the executable trajectory for each unmanned vehicle to one or more first unmanned vehicles of the plurality, wherein the communicative connection is a first communicative connection and wherein the one or more first unmanned vehicles of the plurality are in a second communicative connection with one or more second unmanned vehicles of the plurality; and
transmitting, via the second communicative connection, each executable trajectory for each one or more second unmanned vehicles to each of the one or more second unmanned vehicles.

20. The method of claim 11, further comprising:
generating, by the at least one processor, one or more visual representations including at least one of a current Voronoi tessellation, the current target deployment location of each unmanned vehicle, or the demand density map; and
transmitting the one or more visual representations to at least one operator computing device in communicative connection with the at least one computing device.
